(19) United States
(12) Patent Application Publication
(10) Pub. No.: US 2014/0223284 A1
(43) Pub. Date: Aug. 7, 2014

(54) MACHINE LEARNING DATA ANNOTATION APPARATUSES, METHODS AND SYSTEMS

(71) Applicant: BrokerSavant, Inc., Chicago, IL (US)

(72) Inventors: Claiborne R. Rankin, JR., Chicago, IL (US); Emilia Antonova Apostolova, Chicago, IL (US)

(73) Assignee: BrokerSavant, Inc., Chicago, IL (US)

(21) Appl. No.: 14/169,661

(22) Filed: Jan. 31, 2014

Related U.S. Application Data
(60) Provisional application No. 61/768,815, filed on Feb. 25, 2013.
(60) Provisional application No. 61/759,959, filed on Feb. 1, 2013.

(51) Int. Cl. G06F 17/24

(52) U.S. Cl. CPC G06F 17/248
USPC 715/234

(57) ABSTRACT

The MACHINE LEARNING DATA ANNOTATION APPARATUSES, METHODS AND SYSTEMS (“MLDA”)discloses a processor-implemented confidence structured output document creation method which comprises, in one embodiment, receiving a unknown inconsistent structured document and receiving an confidence information extraction feature. The MLDA may parse the unknown inconsistent structured document to retrieve data field tags and data field values and process the data field tags and the data field values with the confidence information extraction feature. The MLDA may extract processed data field tags and data field values, and provide processed data field tags and data field values to a confidence structured output document learning engine. The MLDA may retrieve a confidence structured output document web form template, populate the confidence structured output document web form template with the extracted data field tags and data field values to generate a confidence structured output document, and provide the confidence structured output document.

### PRIORITY CLAIM

Applicant hereby claims priority under 35 USC §119 to provisional U.S. patent application Ser. No. 61/759,959, filed Feb. 1, 2013, entitled “Machine Learning Data Annotation Apparatuses, Methods and Systems,” attorney docket no. BROK-002/00US 318548-2008, and Ser. No. 61/768,815, filed Feb. 25, 2013, entitled “Machine Learning Data Annotation Apparatuses, Methods and Systems,” attorney docket no. BROK-002/01US 318548-2009. The entire contents of the aforementioned applications are herein expressly incorporated by reference.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address testing, and more particularly, include MACHINE LEARNING DATA ANNOTATION APPARATUSES, METHODS AND SYSTEMS.

### BACKGROUND

Data are organized, sorted, and presented. A machine learning system can be trained to learn from existing data and predict new data.

### BRIEF DESCRIPTION OF THE DRAWINGS

The accompanying appendices and/or drawings illustrate various non-limiting, example, innovative aspects in accordance with the present descriptions:

FIG. 1A shows a block diagram illustrating annotation tool embodiments of the MLDA;

FIG. 1B shows an example user interface of the annotation tool embodiments of the MLDA;

FIGS. 1C-1D show example user interface of the annotation training tool of the MLDA;

FIGS. 1E-1M show example unprocessed data in some embodiments of the MLDA;

FIGS. 1N-1O show example unprocessed training data in some embodiments of the MLDA.

FIG. 2A shows a logic flow diagram illustrating annotation tool embodiments of the MLDA;

FIGS. 2B-2J show example Radmin tool to text annotation in some embodiments of the MLDA.

FIG. 3 shows a block diagram illustrating PDF creation embodiments of the MLDA;

FIG. 4 shows a logic flow diagram illustrating PDF creation embodiments of the MLDA;

FIGS. 5A-5I show examples of PDF creation user interface in some embodiments of the MLDA;

FIG. 5J shows an example MLDA-created property PDF flyer in some embodiments of the MLDA;

FIGS. 6A and 6B show screenshots of example user interface of the lease extraction embodiment of the MLDA;

FIG. 6C shows an example lease creator embodiment of the MLDA;

FIGS. 6D-6E show example Machine Learning performance (F1-score) results in one embodiment of the MLDA;

FIG. 7 shows a block diagram illustrating embodiments of a MLDA controller;

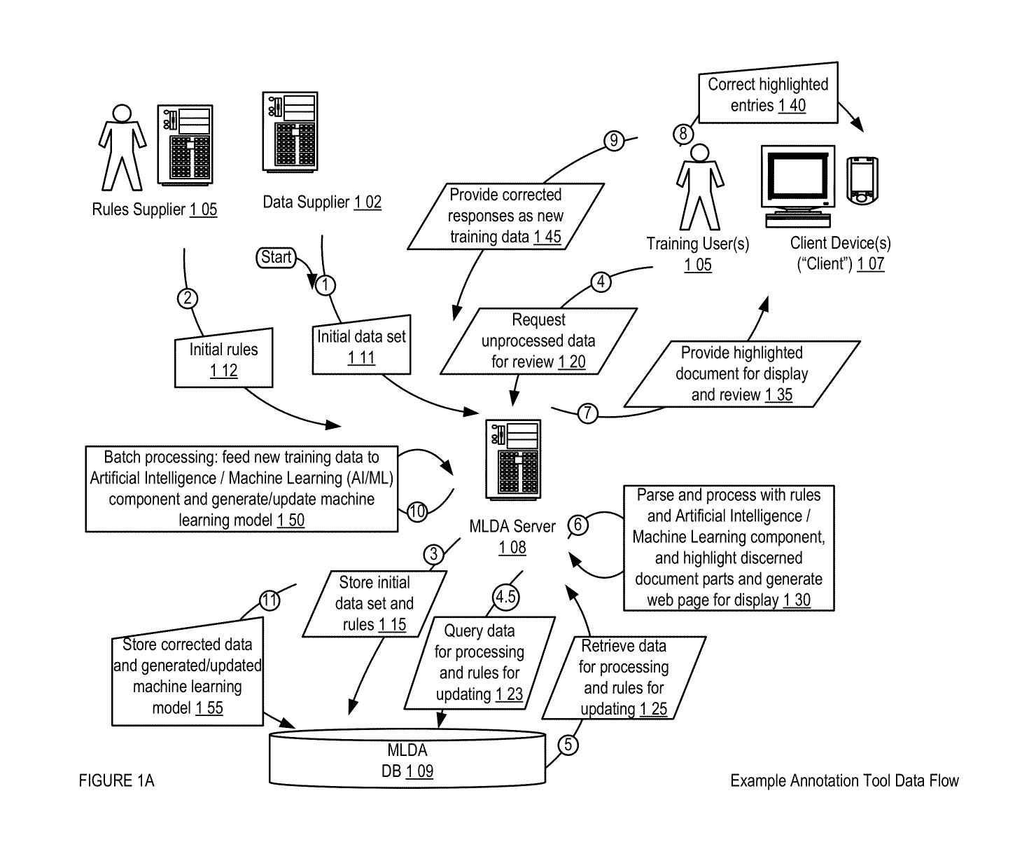

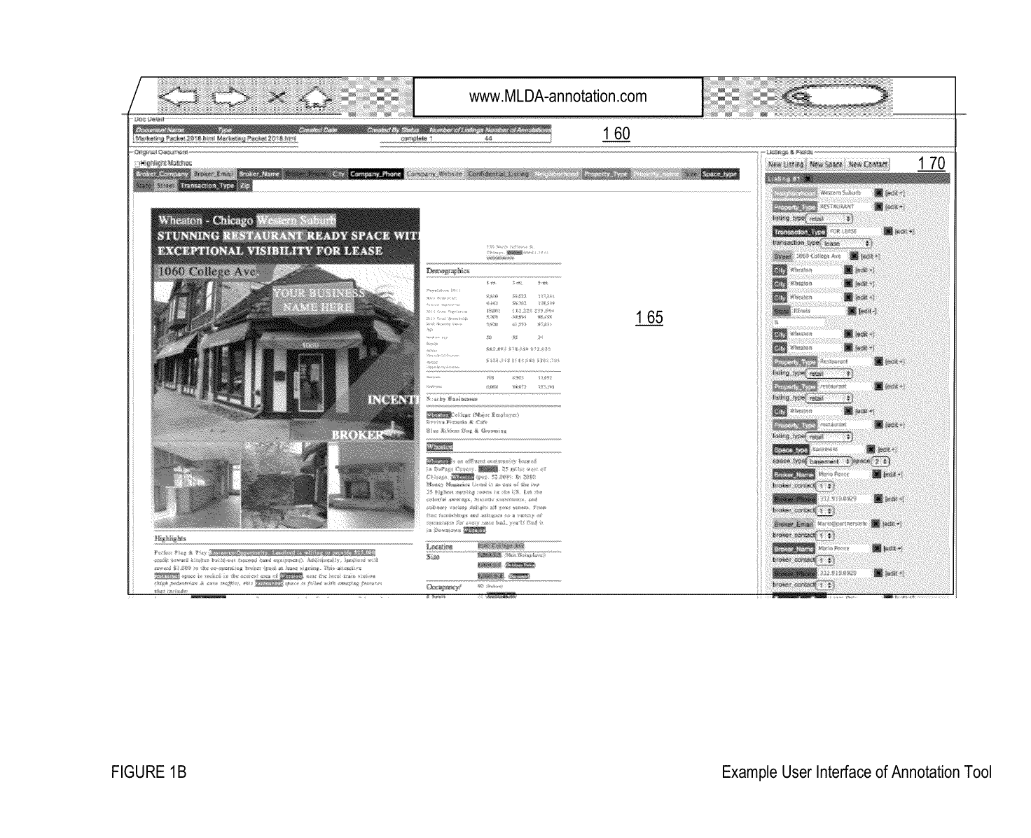

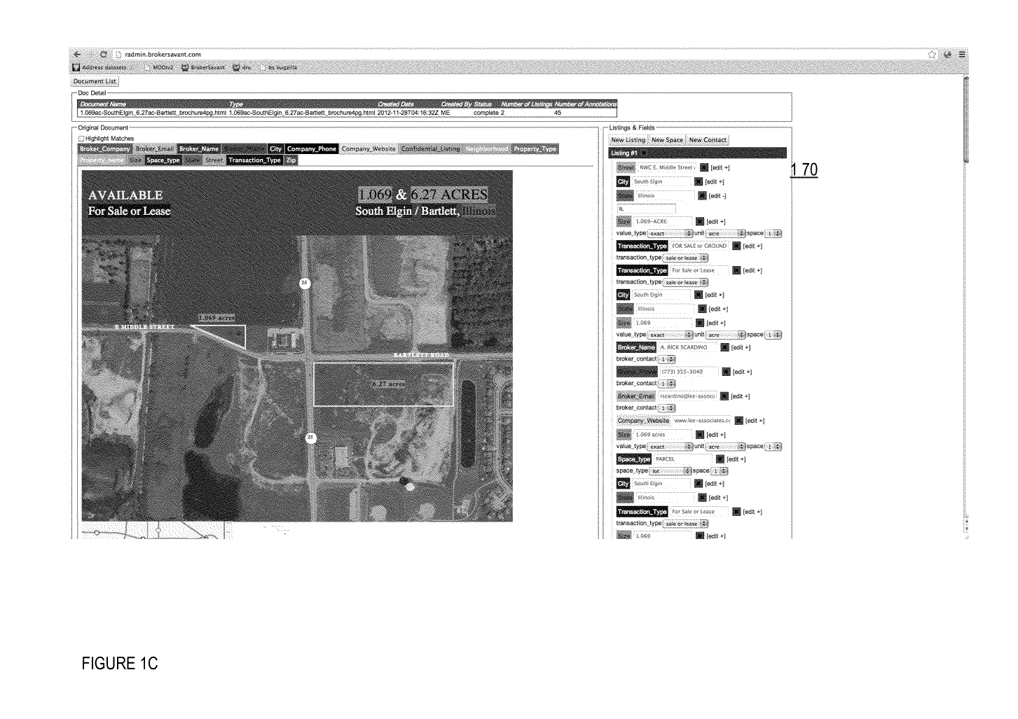

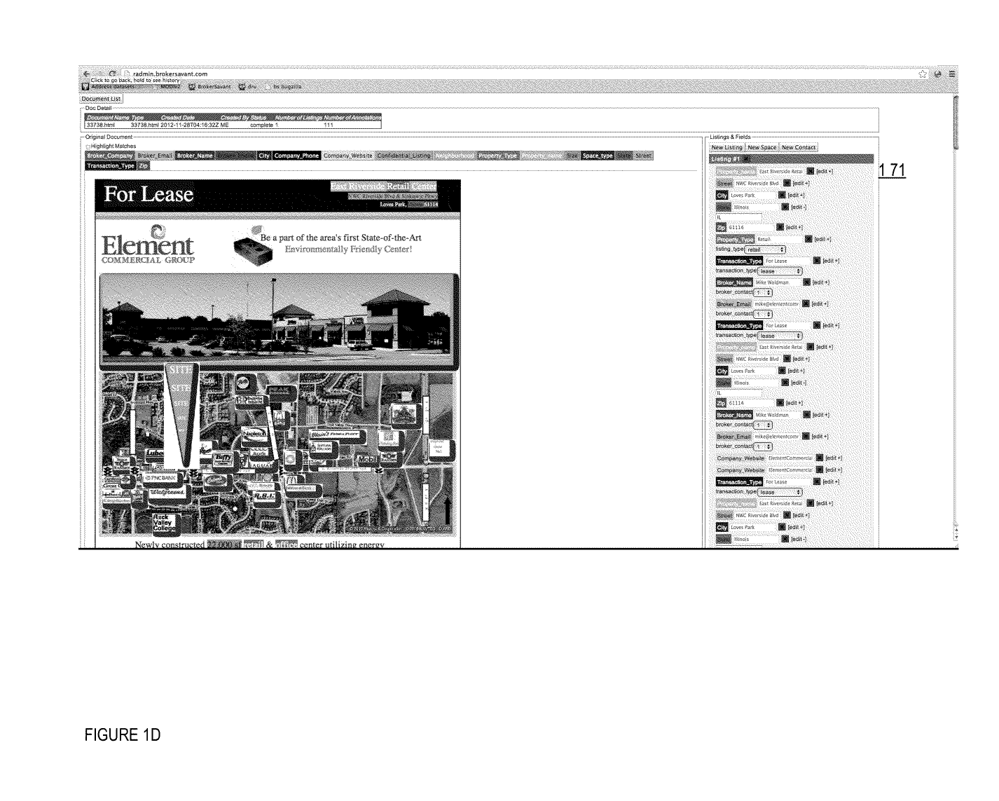

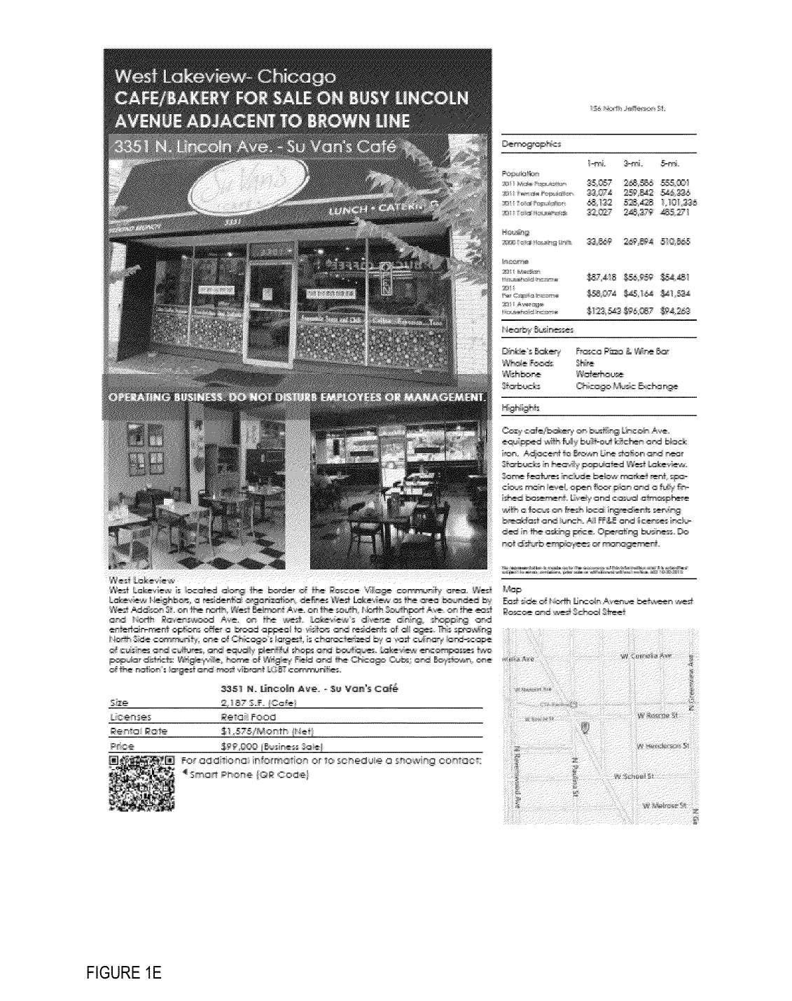

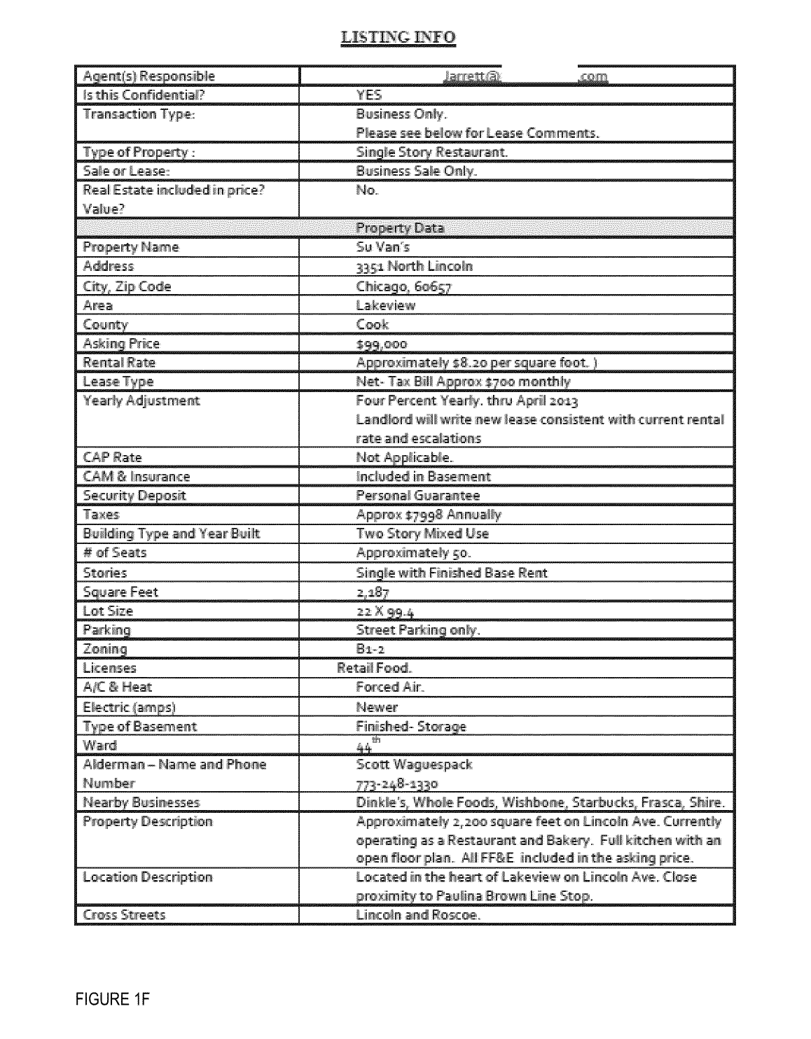

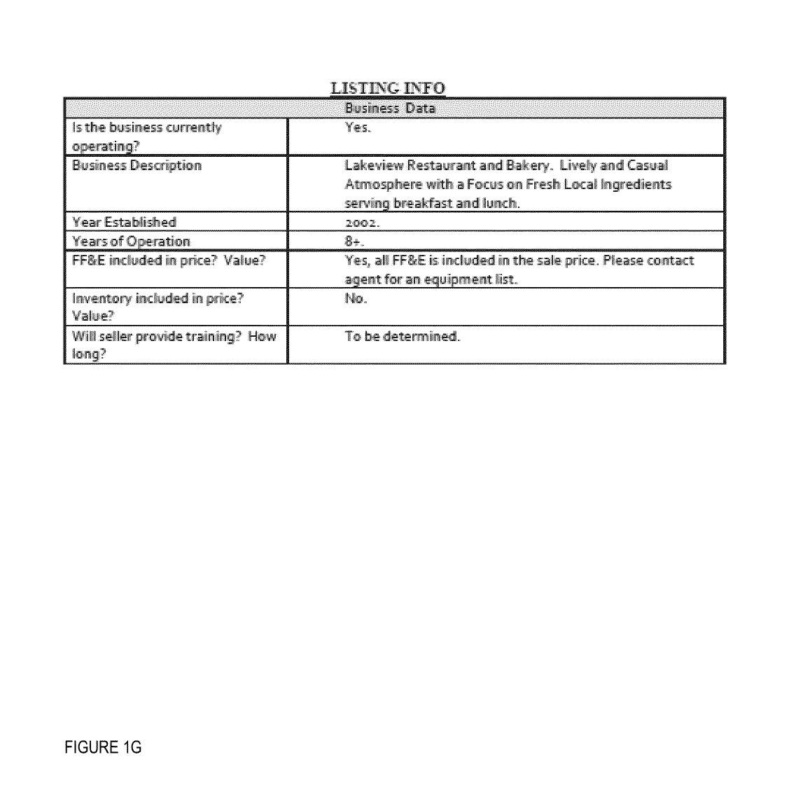

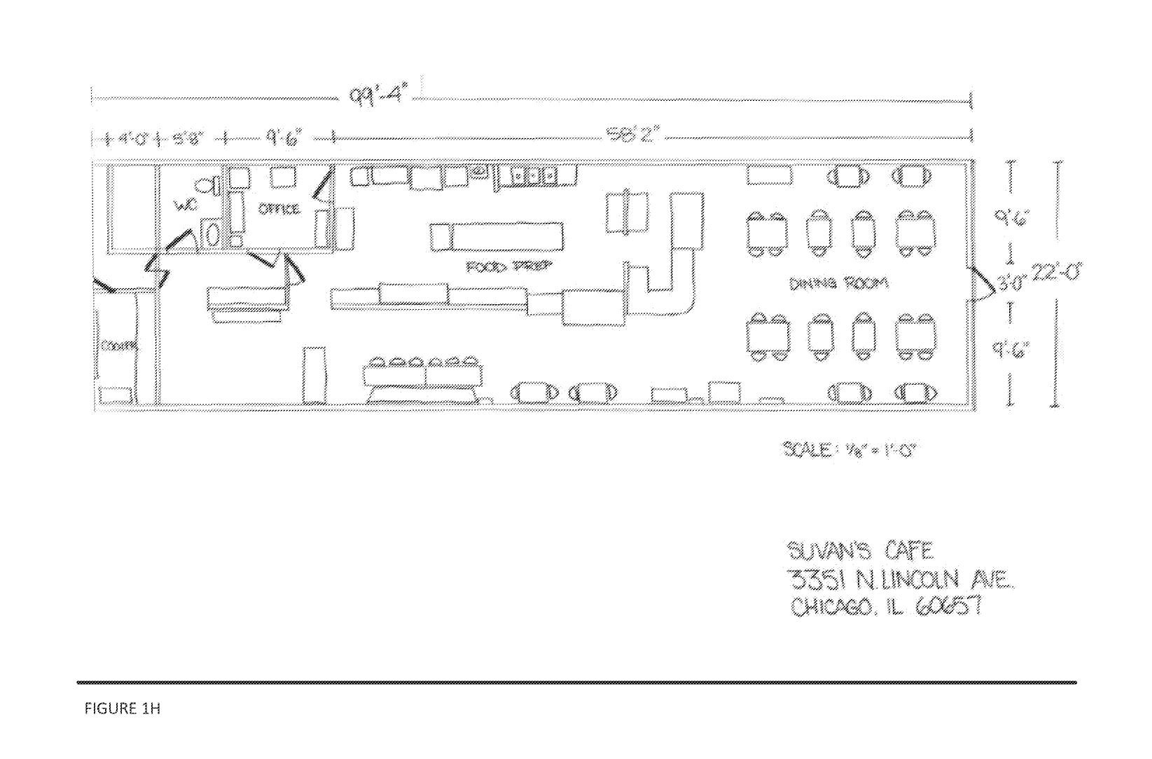

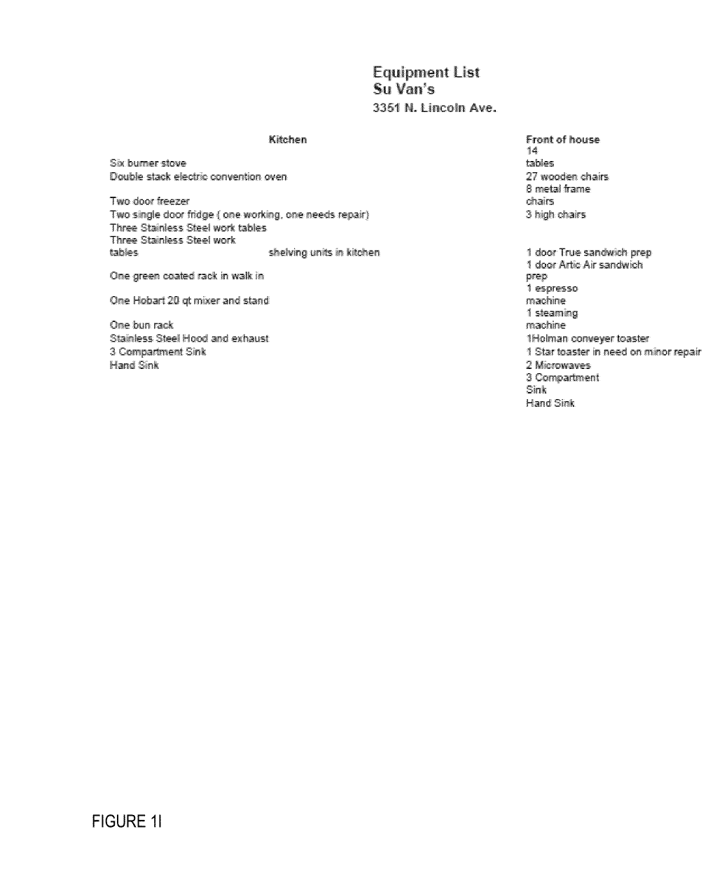

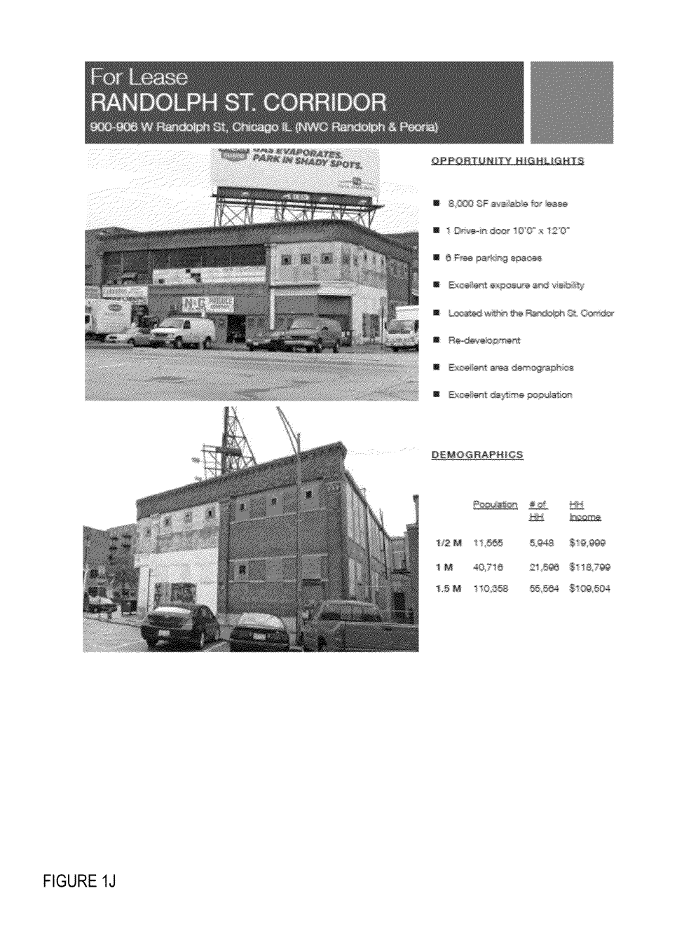

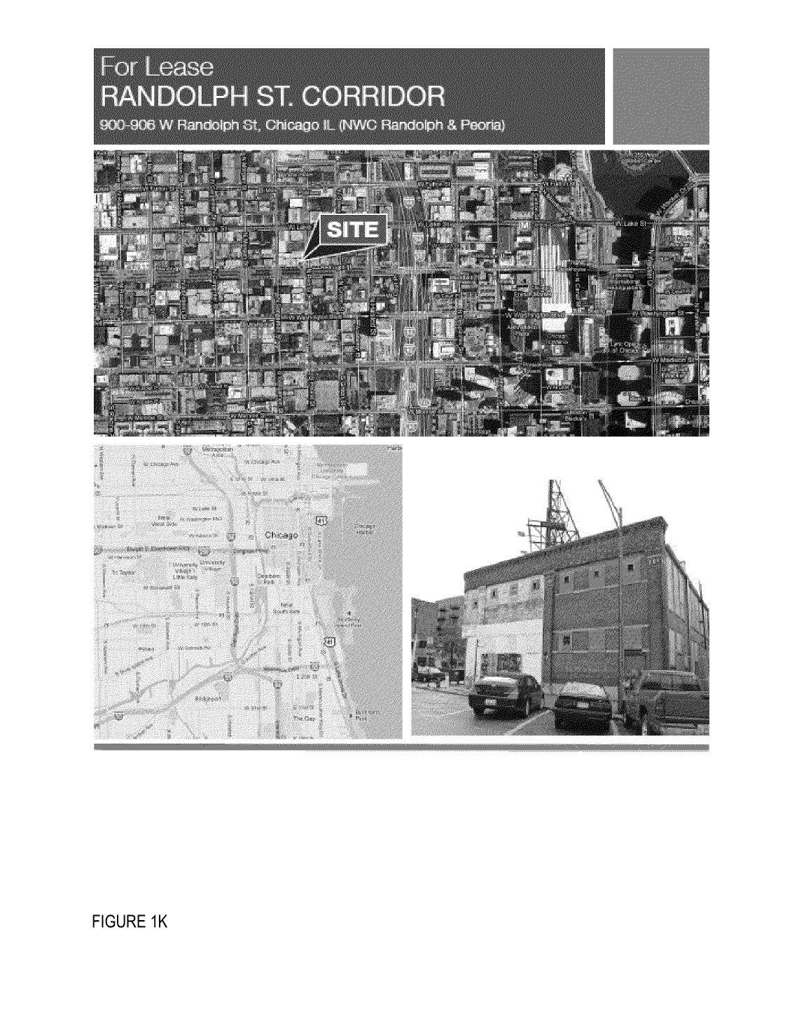

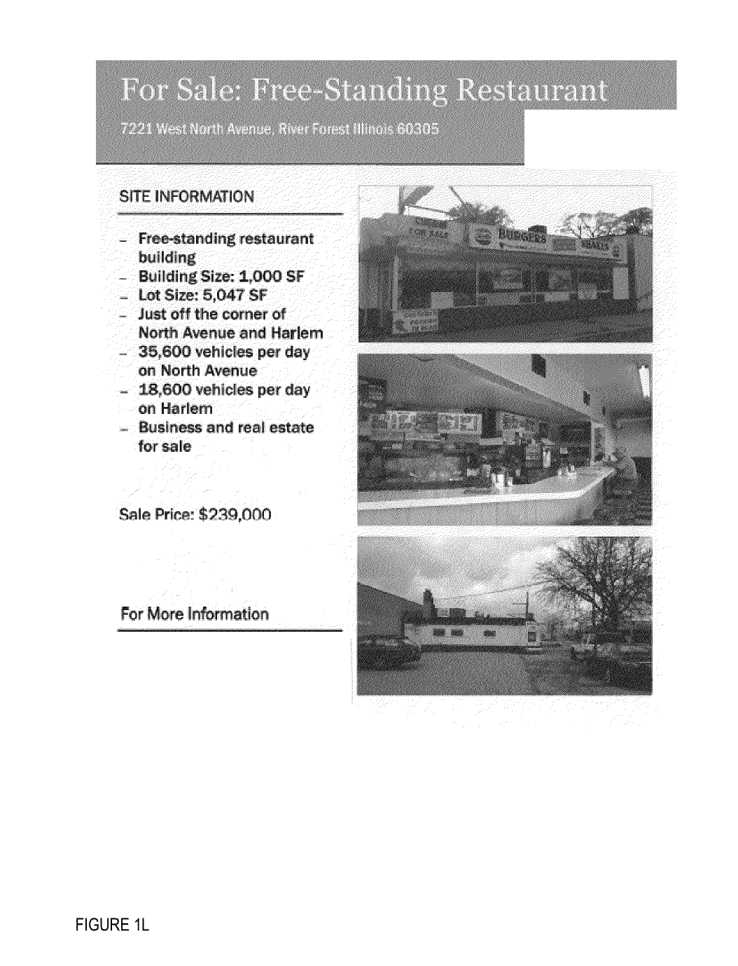

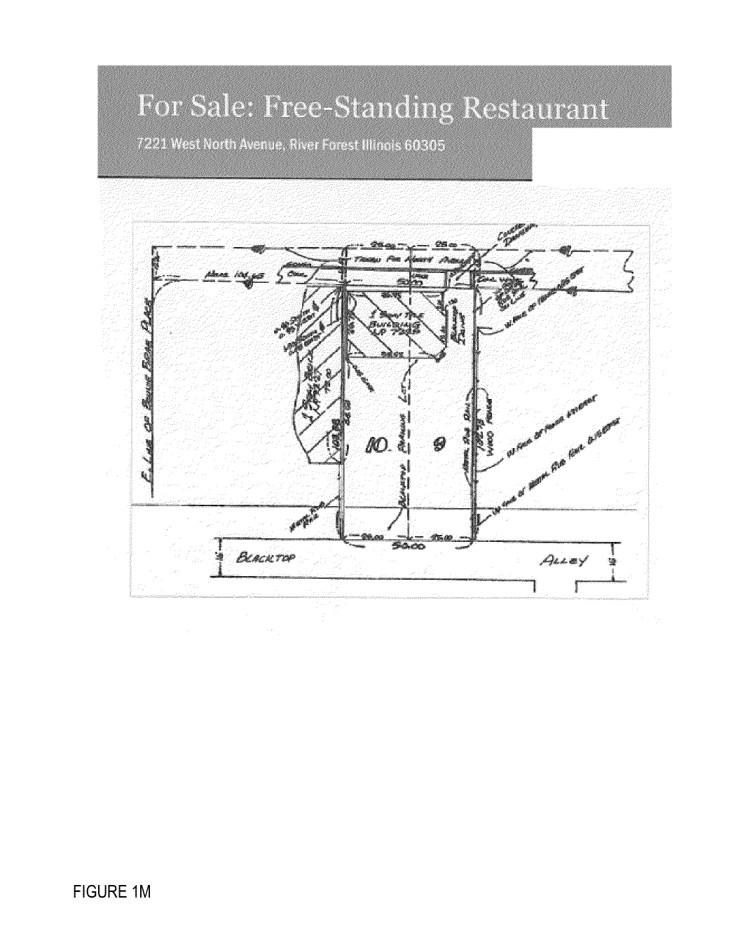

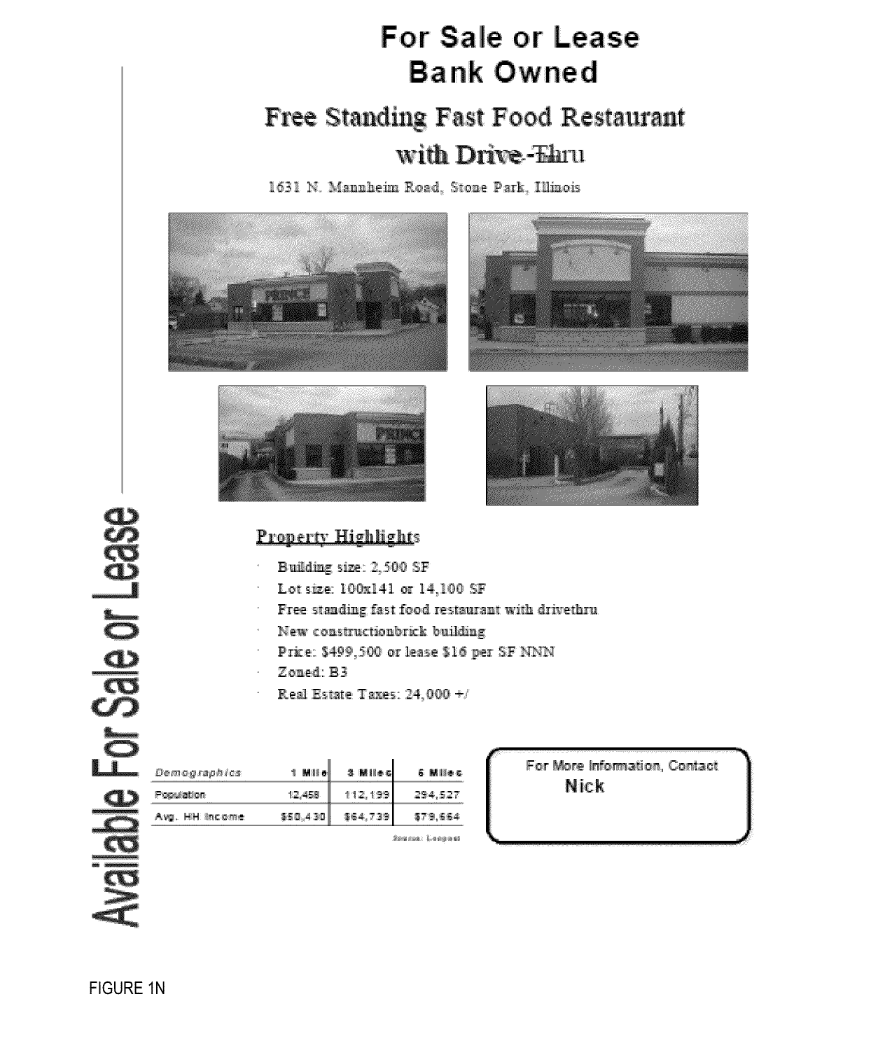

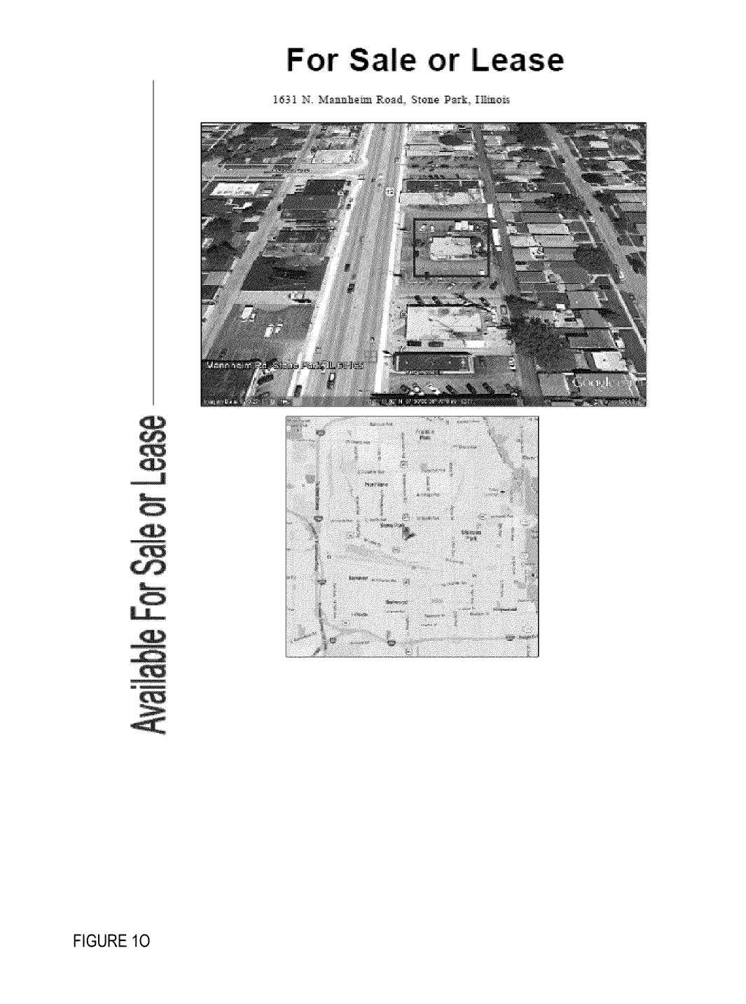

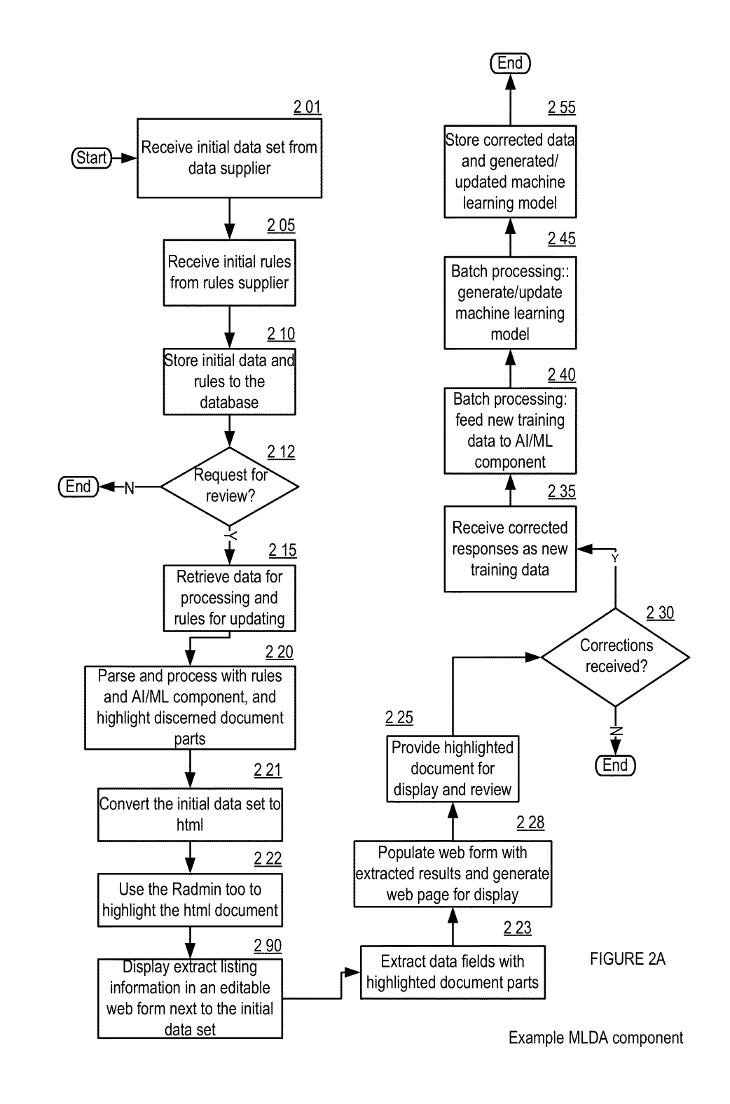

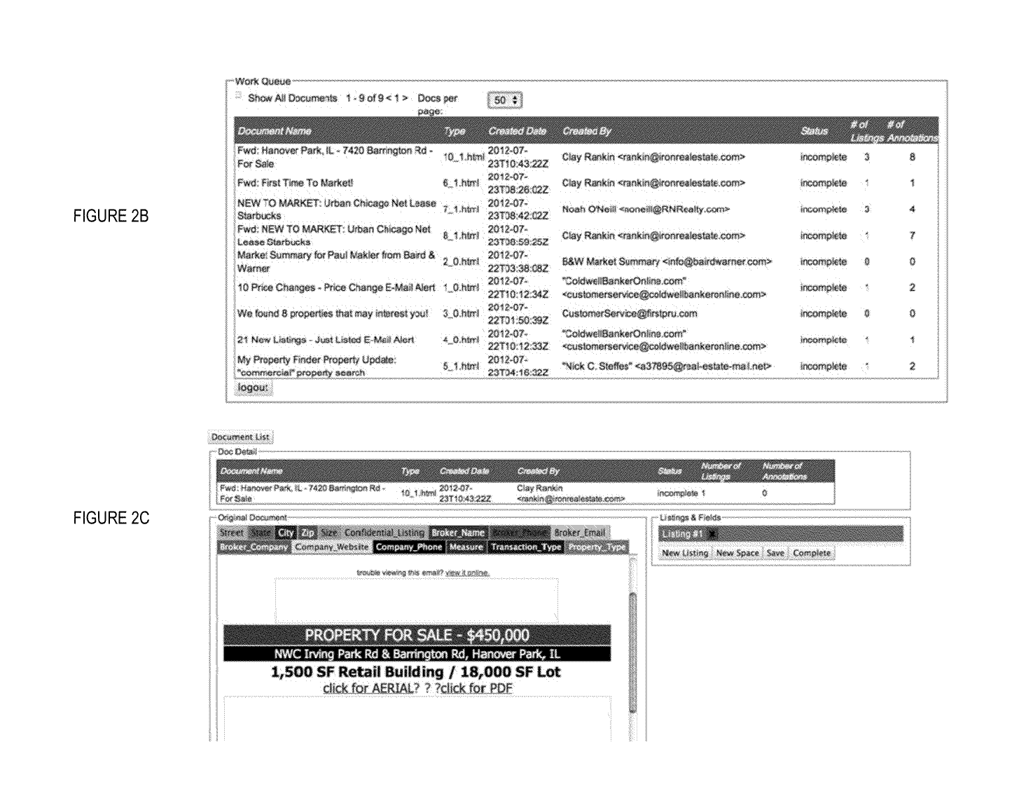

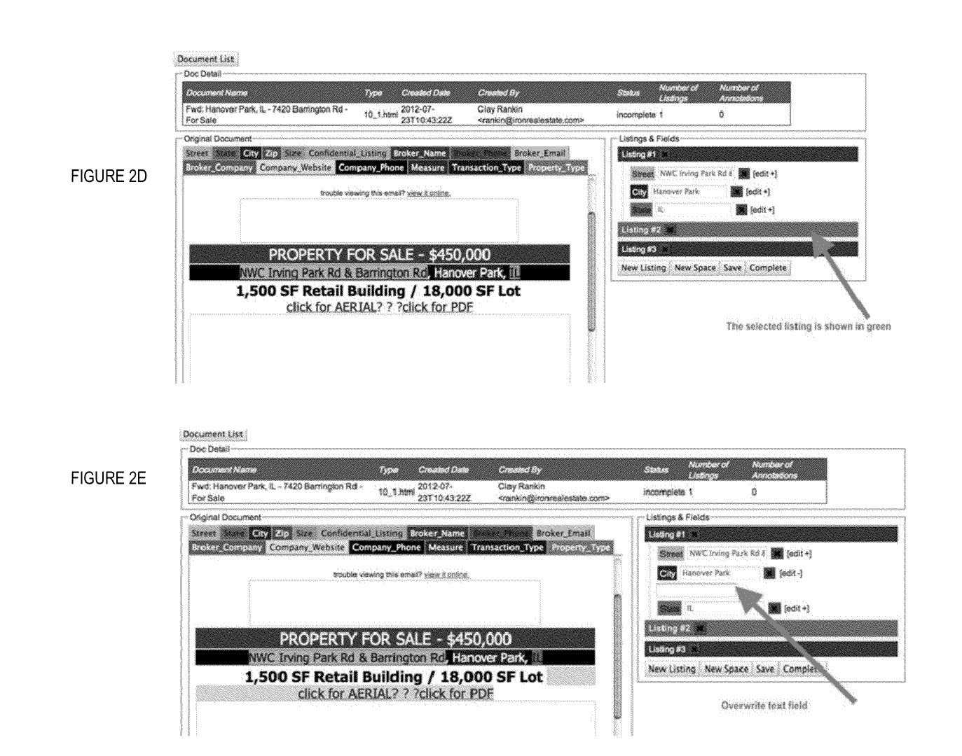

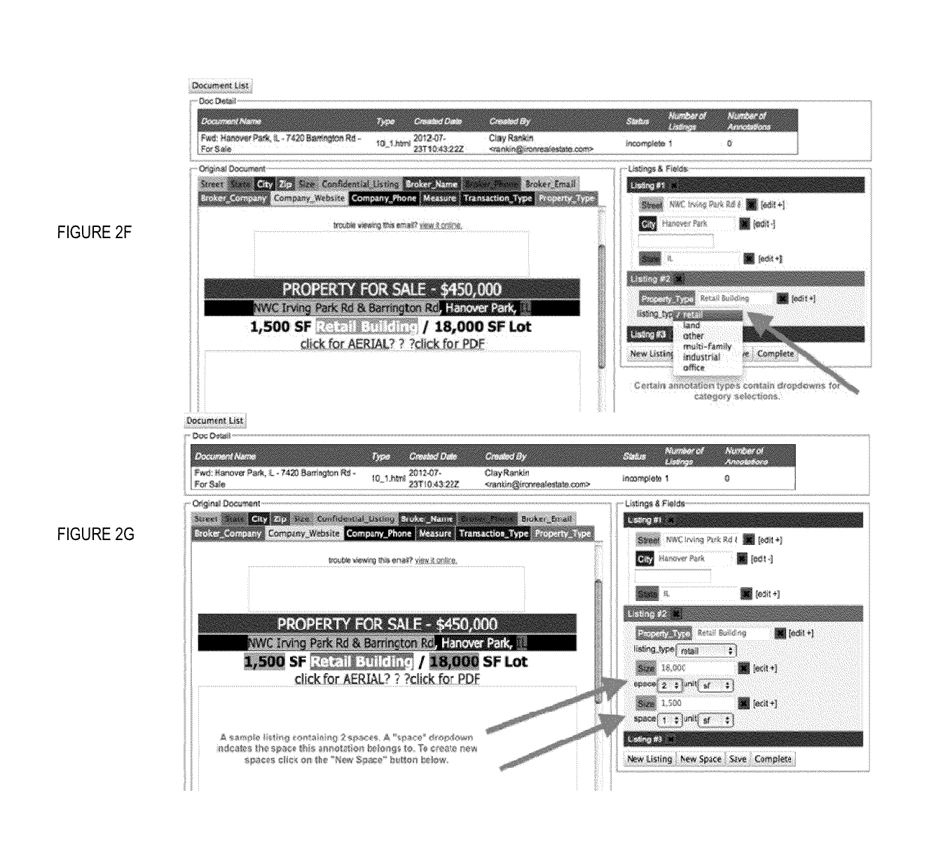

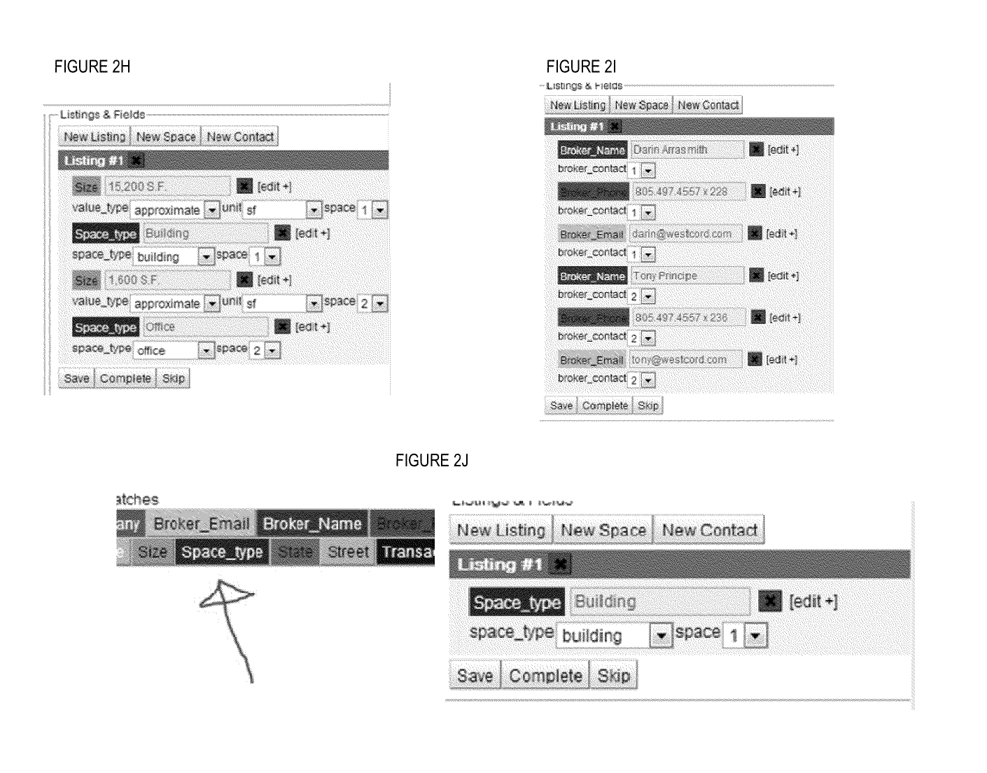

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Introduction

The MACHINE LEARNING DATA ANNOTATION APPARATUSES, METHODS AND SYSTEMS (“MLDA”) transforms data annotation request and Portable Document Format (PDF) creation request inputs via MLDA annotation tool and PDF creation components, into annotated data representation and data PDF representation outputs.

Commercial real estate brokerage firms, municipalities and a variety of professional and economic associations may need to showcase their available properties on their own websites. In one embodiment, MLDA system may turn free-text into structured data and may be applied to many verticals and accommodate different industries (configurable set of Information Extraction Entities), including the employment, heavy equipment brokerage, business brokerage industries, financial, and/or the like.

In one embodiment, the MLDA may comprise a marketing engine which displays available properties from their own website with no manual data entry required. Web traffic may be driven to their website, promoting their brand. The MLDA may comprise an email broadcast engine which furthers Municipalities' engagement and unification efforts with the brokerage community. The MLDA may comprise a PDF Creator engine which creates interactive flyers that impress and provide brand consistency without hassle and effort.

The US commercial real estate market is a >$1.3B industry. >94% of CRE firms are <15 people and 70% of CRE individuals work in small firms. The MLDA may comprise an Email and Direct Marketing engine which includes Proprietary National Contact Databases and Drip Campaigns. The MLDA may comprise a Digital Marketing engine which includes PPC Campaigns, Retargeting Ads, Conversion Optimization, LinkedIn and Twitter. The MLDA may comprise a Content Marketing engine which includes Webcasts, White Papers, Infographics, Blogging and Speaking Engagements. The MLDA may comprise an Association Sell Through engine which indlues National, Regional & Local Organizations, Conferences and Trade Shows. The MLDA may comprise a Referral Marketing engine which includes Affiliate Programs, Municipal Donation Rewards and 'Word of Mouth.

The MLDA system may be used by small brokerage firms, municipalities, chambers of commerce, and/or the like, as a business-to-business embodiment. The MLDA system may also be used by individual broker as a business-to-customer embodiment. Small organizations, individual practitioners and others may struggle with marking due to limited time, limited human resources, and limited budget. The MLDA may comprise a marketing engine, an email broadcast engine, a PDF creator engine, and a document annotation engine. The MLDA may use existing flyers, therefore may not need manual entry. The MLDA may provide one-click browsing, sleek user interface, unlimited contributors, be priced for small budgets, and reduce burden on Information Technology infrastructure. The MLDA may accept multiple types of listing data from multiple sources to inform, market to, and educate the industry.

In one embodiment, the MLDA may extract unstructured data from documents such as PDFs, emails, Microsoft Word, text messages, websites, multimedia sources, and generate structured data including listing address, transaction type size, lease/sale price, broker contact information, broker company, and/or the like. The MLDA may identify in free-text a set of pre-defined entities of interest (i.e. listing attributes—address, broker information, etc.) using Natural Language Processing 11 (“NLP”) and/or Machine Learning (“ML”). In one embodiment, a set of training data may be provided to the MLDA. Training data contains annotated and/or extracted data entered manually by trainers. The MLDA may use the training data with machine learning and generate a machine learning model. The machine learning model may be further used to annotate and extract new data. Trainers may optionally validate the annotated and/or extracted data manually. The information extraction may be approached with a combination of handwritten regular expressions, industry-specific lexicons, US census bureau data, and supervised machine learning (e.g., Support Vector Machines). An accuracy of 70-90% may be achieved (e.g., F1-score). The MLDA approach may be extended to accommodate different industries other than the real estate industry. The MLDA may integrate a crowdsourcing solution with the manual data entry application. The NLP model and machine learning model may be updated and improved with new annotated and/or extracted data.

In one embodiment, trainers may be given instructions of how to annotate documents manually so that the data may be used as an input to a Machine Learning algorithm.

In some embodiments, the Machine Learning system of the MLDA may be used to extract information and/or annotate legal documents, contracts, leases, and/or the like. The MLDA may have training users (e.g., attorneys) to annotate a large number of legal documents. The annotations may be used as training data for machine learning. The MLDA may train a machine learning algorithm to identify paragraphs relevant to an abstraction field. The MLDA may identify the abstraction field values within previously identified paragraphs, or categorized paragraphs for enumerated field types (i.e., rent type, TI allowance, etc).

In one embodiment, the training user may identify paragraph(s) that referenced lease data for abstraction. The MLDA may generate NLP (Natural Language Processing) features using the words within each paragraph and adjacent context. The MLDA may generate ML (Machine Learning) model using ML algorithm, e.g., SVM (Support Vector Machines).

In one embodiment, the MLDA may utilize existing NLP (Natural Language Processing) and ML (Machine Learning) models generated from the training data to pre-populate field values in web interface using identified paragraphs of relevant lease abstraction fields.

In one embodiment, the MLDA ML system may be used in a search engine. The search results and user's click to one of the search results may be fed into the MLDA ML system for training and provide a intelligent spidering model, web crawler, search engine, and/or the like.

### MLDA

FIG. 1A shows a block diagram illustrating annotation tool embodiments of the MLDA. In one embodiment, the MLDA may receive unstructured data (e.g., real estate property listing, and/or the like) and process the data so that it is represented with structures and annotations. Training users may correct the system processed structures and annotations and update the corrections with the system. The MLDA may learn from the corrections and provide more appropriate structures and annotations through artificial intelligence machine learning techniques. For example, in one embodiment, a data supplier 102 may provide initial data set 111 to the MLDA server 108. For example, a browser application executing on the data supplier's client may provide, on behalf of the data supplier, a (Secure) Hypertext Transfer Protocol (“HTTP(S)”) GET message including the initial data set details for the MLDA server in the form of data formatted according to the eXtensible Markup Language (“XML”). Below is an example HTTP(S) GET message including an XML-formatted initial data set 111 for the MLDA server:

GET /initialdataset.php HTTP/1.1
Host: www.MLDA.com
Content-Type: Application/XML
Content-Length: 1306
<?XML version = “1.0” encoding = “UTF-8”?>
<initial_data_set>

<training_data_ID>4NFU4RG94</training_data_ID>
<timestamp>2002-02-22 15:22:43</timestamp>
<document_ID>987654</document_ID>
<industry_ID>34DGH1</industry_ID>
<document_type>pdf</document_type>
<training_data_file>file1.pdf</training_data_file>

</initial_data_set>

The rules supplier (e.g., a rule manager, or a rule supplier server, etc.) may provide initial rules 112 to the MLDA server. Below is an example HTTP(S) GET message including an XML-formatted initial rules 112 for the MLDA server:

GET /initialrules.php HTTP/1.1
Host: www.MLDA.com
Content-Type: Application/XML
Content-Length: 1306
<?XML version = “1.0” encoding = “UTF-8”?>
<initial_rules>

<annotation_industry_ID>93DGH1</annotation_industry_ID>
<rule_1>

<data_field>US states</data_field>
<annotation_flag>Yes</annotation_flag>
<annotation_color>green</annotation_color>
<annotation_category>property_location

state</annotation_category>

</rule_1>
<rule_2>

<data_field>US Cities</data_field>
<annotation_flag>Yes</annotation_flag>
<annotation_color>red</annotation_color>
<annotation_category>property_location

city</annotation_category>

</rule_2>

</initial_rules>

The MLDA server may store 115 the initial data set and the initial rules to the MLDA database 109. In one embodiment, one or more training users 105 may provide a request to review the unprocessed data 120 through its client device(s) 107 (e.g., computers, mobile, etc.). For example, a browser application executing on the training user's client may provide, on behalf of the training user, a (Secure) Hypertext Transfer Protocol (“HTTP(S)”) GET message including the review unprocessed data request details for the MLDA server in the form of data formatted according to the eXtensible Markup Language (“XML”). Below is an example HTTP(S) GET message including an XML-formatted review unprocessed data request 120 for the MLDA server:

GET /reviewunprocesseddatarequests.php HTTP/1.1
Host: www.MLDA.com
Content-Type: Application/XML
Content-Length: 1306
<?XML version = “1.0” encoding = “UTF-8”?>
<review_unprocessed_data_request>

<training_user_ID>KevinSmith</training_user_ID>
<training_data_ID>4NFU4RG94</training_data_ID>
<document_ID>987654</document_ID>
<industry_ID>34DGH1</industry_ID>
<document_type>pdf</document_type>
<training_data_file>file1.pdf</training_data_file>

</review_unprocessed_data_request I

Upon receiving the request to review the unprocessed data, the MLDA server may send a query to the database for data for processing and rules for updating 123, and then may retrieve 125 from the database initial data for processing, and initial rules for updating. The MLDA may parse the initial data to obtain data fields, and process the data fields with rules using the Artificial Intelligence/Machine Learning component to highlight discerned document parts and generate a webpage for display 130. The MLDA may provide the highlighted document and/or the web page for display and review for the training user 135. For example, the MLDA server may provide a HTTP(S) POST message 135 similar to the example below:

POST /highlighteddocumentforreview.php HTTP/1.1
Host: www.MLDA.com
Content-Type: Application/XML
Content-Length: 788
<?XML version = “1.0” encoding = “UTF-8”?>
<highlighted_document_for_review>

<training_user_ID>KevinSmith</training_user_ID>
<training_data_ID>4NFU4RG94</training_data_ID>
<document_ID>987654</document_ID>
<industry_ID>34DGH1</industry_ID>
<document_type>pdf</document_type>
<training_data_file>file1.pdf</training_data_file>
<annotation_details>

<data_field_1>Maryland</data_field_1>
<annotation_flag_1>Yes</annotation_flag_1>
<annotation_color_1>green</annotation_color_1>
<annotation_category_1>property location

state</annotation_category_1>

<data_field_2>Baltimore</data_field_2>
<annotation_flag_2>Yes</annotation_flag_2>
<annotation_color_2>red</annotation_color_2>
<annotation_category_2>property location city

</annotation_category_2>

<data_field_3>18000 square feet</data_field_3>
<annotation_flag_3>No</annotation_flag_3>

</highlighted_document_for_review>

The training user may, through its client device, correct the highlighted entries 140 and provide corrected responses as new training data 145. Below is an example HTTP(S) GET message including an XML-formatted corrected responses 145 for the MLDA server:

GET /correctedresponses.php HTTP/1.1
Host: www.MLDA.com
Content-Type: Application/XML
Content-Length: 1306
<?XML version = “1.0” encoding = “UTF-8”?>
<corrected_responses>

<training_user_ID>KevinSmith</training_user_ID>
<training_data_ID>4NFU4RG94</training_data_ID>
<document_ID>987654</document_ID>
<industry_ID>34DGH1</industry_ID>
<document_type>pdf</document_type>
<training_data_file>file1.pdf</training_data_file>
<updated_annotation_details>

<data_field_1>Maryland</data_field_1>
<annotation_flag_1>Yes</annotation_flag_1>
<annotation_color_1>green</annotation_color_1>
<annotation_category_1>property location

state</annotation_category_1>

<data_field_2>Baltimore</data_field_2>
<annotation_flag_2>Yes</annotation_flag_2>
<annotation_color_2>red</annotation_color_2>
<annotation_category_2>property location city

</annotation_category_2>

<data_field_3>18000 square feet</data_field_3>
<annotation_flag_3>Yes</annotation_flag_3>
<annotation_color_3>yellow</annotation_color_3>
<annotation_category_3>property
size</annotation_category_3>

</annotation_details>

</corrected_responses>

The MLDA may feed the new training data to Artificial Intelligence/Machine Learning component and generate and/or update machine learning model 150, and store the corrected data and the generated/updated machine learning model 155 to the database.

In one embodiment, The ML algorithm may classify individual words (tokens) into one of several categories (e.g. lease size, broker email, listing street address, etc.). To use this it may create a model using the following features:

The preceding 5 and following 5 tokens.

The orthography of the preceding 5 and following 5 tokens (e.g. All caps, camel case, lower case word).

The kind of the preceding 5 and following 5 tokens (e.g. number, word, punctuation).

Preceding and following named entities based on a set of regular expression rules that identify phone numbers, zip codes, emails, urls.

Preceding and following named entities based on US Census data that identify words that refer to US cities and states.

The html font size and font weight of the 5 preceding and following HTML DOM elements that contain text data.

In one implementation, the machine learning model may be generated and/or updated when one new training data document is received. In another implementation, the machine learning model may be generated/or updated when multiple new training data documents are received.

In one embodiment, a number of documents may be annotated by human annotators and used as training data. The documents and their annotations may be converted to a set of features (e.g., variables) that may be fed into a machine learning (ML) algorithm such as Support Vector Machines, and/or the like. A set of Natural Language Processing (NLP) features using domain specific data sources and document structure representation may be incorporated into the ML component.

In one embodiment, the ML algorithm may provide an ML model that may be used to “mimic” human annotations automatically. The model may be used to extract relevant information from documents. A portion of the automatically annotated documents may set aside for human validation (based on ML confidence score, i.e. a threshold probability that the extracted information is correct).

In one embodiment, the model may be updated periodically by introducing a small amount of new documents (additional training data) annotated by human annotators.

FIG. 1B shows an example user interface of the annotation tool embodiments of the MLDA. For example, the data is about a property listing 160 in real estate industry. The MLDA training engine may provide an initial set of annotations of the data as shown in section 165. A training user may correct the annotations in section 170 of the user interface with any inappropriate annotations that the MLDA server makes. The MLDA may update its database with the corrections and make future annotations based on the corrections.

FIGS. 1C-1D show example user interface of the annotation training tool of the MLDA. For example, a person may use the interface to manually validate the data annotated by the machine learning algorithm. The person (or trainer) may edit 170 and 171 each attribute and extraction field. The newly validated data may be fed into the machine learning program to update and improve the model.

FIGS. 1E-1M show example unprocessed data in some embodiments of the MLDA. In some embodiments, the MLDA may receive a request to annotate documents. Example unprocessed data as shown in FIGS. 1E-1M may be provided to the MLDA. The MLDA may use the Machine Learning system to analyze, extract, and/or annotate the data. The unprocessed data may be property flyers in PDF forms, as illustrated in FIG. 1E, a table with listing information as shown in FIGS. 1F, 1G and 1I, a block diagram with a map of the property as shown in FIG. 1H, or other unstructured forms as illustrated in FIGS. 1J-1M.

FIGS. 1N-1O show example unprocessed training data in some embodiments of the MLDA. Unprocessed training data are provided to the traning users to provide annotation or validations manually. Below is an example data message (e.g., 111) sent from the training user to the MLDA server:

\n\n\n”, “key”: “FwdBANKOWNEDFREESTANDINGWITHDRIVETHRU.html”, “name”:
“FwdBANKOWNEDFREESTANDINGWITHDRIVETHRU.html”, “created_by”:
“brokers@gmail.com”, “listing”: [ { “id”: 17592186252124, “client_id”: 0,
“annotation”: [ { “text”: “For Sale or Lease”, “offset”: 0, “overwrite_text”:
“”, “client_id”: 0, “length”: 17, “selected_properties”: [ { “id”:
17592186252097, “name”: “transaction_type”, “value”: “sale or lease” } ],
“originalHtmlSelection”: “”, “htmlHighlight”: “”, “tag”: { “id”:
17592186045429, “name”: “Transaction_Type”, “color”: “white”, “background”:
“navy”, “overwrite”: true, “properties”: [ { “id”: 17592186045428, “name”:
“transaction_type”, “values”: [“sale”, “investment”, “sale or lease”, “lease”]
} ] }, “id”: 17592186252074 }, { “text”: “Free Standing”, “offset”: 0,
“overwrite_text”: “”, “client_id”: 1, “length”: 13, “selected_properties”: [ {
“id”: 17592186252098, “name”: “space_type”, “value”: “building” }, { “id”:
17592186252099, “name”: “space”, “value”: “1” } ], “originalHtmlSelection”: “”,
“htmlHighlight”: “”, “tag”: { “id”: 17592186045427, “name”: “Space_type”,
“color”: “white”, “background”: “maroon”, “overwrite”: true, “properties”: [ {
“id”: 17592186045425, “name”: “space_type”, “values”: [“unit”, “parking_lot”,
“basement”, “other”, “lot”, “building”, “gla”, “office”] }, { “id”:
17592186045426, “name”: “space”, “values”: [“1”, “2”] } ] }, “id”:
17592186252075 }, { “text”: “Fast Food Restaurant”, “offset”: 0,
“overwrite_text”: “”, “client_id”: 2, “length”: 20, “selected_properties”: [ {
“id”: 17592186252100, “name”: “listing_type”, “value”: “retail” } ],
“originalHtmlSelection”: “”, “htmlHighlight”: “”, “tag”: { “id”:
17592186045431, “name”: “Property_Type”, “color”: “white”, “background”:
“olive”, “overwrite”: true, “properties”: [ { “id”: 17592186045430, “name”:
“listing_type”, “values”: [“retail”, “land”, “other”, “multi-family”,
“industrial”, “office”] } ] }, “id”: 17592186252076 }, { “id”: 17592186252077,
“client_id”: 3, “offset”: 0, “length”: 21, “tag”: { “id”: 17592186045418,
“name”: “Street”, “color”: “black”, “background”: “aqua”, “overwrite”: true },
“text”: “1631 N. Mannheim Road”, “overwrite_text”: “”, “originalHtmlSelection”:
“”, “htmlHighlight”: “” }, { “id”: 17592186252078, “client_id”: 4, “offset”: 0,
“length”: 10, “tag”: { “id”: 17592186045419, “name”: “City”, “color”: “white”,
“background”: “blue”, “overwrite”: true }, “text”: “Stone Park”,
“overwrite_text”: “”, “originalHtmlSelection”: “”, “htmlHighlight”: “” }, {
“id”: 17592186252079, “client_id”: 5, “offset”: 0, “length”: 8, “tag”: { “id”:
17592186045420, “name”: “State”, “color”: “black”, “background”: “fuchsia”,
“overwrite”: true }, “text”: “Illinois”, “overwrite_text”: “IL”,
“originalHtmlSelection”: “”, “htmlHighlight”: “” }, { “text”: “2,500 SF”,
“offset”: 0, “overwrite_text”: “”, “client_id”: 6, “length”: 8,
“selected_properties”: [ { “id”: 17592186252101, “name”: “value_type”, “value”:
“exact” }, { “id”: 17592186252102, “name”: “space”, “value”: “1” }, { “id”:
17592186252103, “name”: “unit”, “value”: “sf” } ], “originalHtmlSelection”: “”,
“htmlHighlight”: “”, “tag”: { “id”: 17592186045424, “name”: “Size”, “color”:
“black”, “background”: “lime”, “overwrite”: true, “properties”: [ { “id”:
17592186047928, “name”: “value_type”, “values”: [“max”, “min”, “approximate”,
“exact”] }, { “id”: 17592186045422, “name”: “unit”, “values”: [“dimension”,
“sf”, “acre”] }, { “id”: 17592186045423, “name”: “space”, “values”: [“1”, “2”]
} ] }, “id”: 17592186252080 }, { “text”: “Lot”, “offset”: 0, “overwrite_text”:
“”, “client_id”: 7, “length”: 3, “selected_properties”: [ { “id”:
17592186252104, “name”: “space_type”, “value”: “lot” }, { “id”: 17592186252105,
“name”: “space”, “value”: “2” } ], “originalHtmlSelection”: “”,
“htmlHighlight”: “”, “tag”: { “id”: 17592186045427, “name”: “Space_type”,
“color”: “white”, “background”: “maroon”, “overwrite”: true, “properties”: [ {
“id”: 17592186045425, “name”: “space_type”, “values”: [“unit”, “parking_lot”,
“basement”, “other”, “lot”, “building”, “gla”, “office”] }, { “id”:
17592186045426, “name”: “space”, “values”: [“1”, “2”] } ] }, “id”:
17592186252081 }, { “text”: “100x141”, “offset”: 0, “overwrite_text”: “”,
“client_id”: 8, “length”: 7, “selected_properties”: [ { “id”: 17592186252108,
“name”: “unit”, “value”: “dimension” }, { “id”: 17592186252106, “name”:
“value_type”, “value”: “exact” }, { “id”: 17592186252107, “name”: “space”,
“value”: “2” } ], “originalHtmlSelection”: “”, “htmlHighlight”: “”, “tag”: {
“id”: 17592186045424, “name”: “Size”, “color”: “black”, “background”: “lime”,
“overwrite”: true, “properties”: [ { “id”: 17592186047928, “name”:
“value_type”, “values”: [“max”, “min”, “approximate”, “exact”] }, { “id”:
17592186045422, “name”: “unit”, “values”: [“dimension”, “sf”, “acre”] }, {
“id”: 17592186045423, “name”: “space”, “values”: [“1”, “2”] } ] }, “id”:
17592186252082 }, { “text”: “14,100 SF”, “offset”: 0, “overwrite_text”: “”,
“client_id”: 9, “length”: 9, “selected_properties”: [ { “id”: 17592186252109,
“name”: “value_type”, “value”: “exact” }, { “id”: 17592186252110, “name”:
“space”, “value”: “2” }, { “id”: 17592186252111, “name”: “unit”, “value”: “sf”
} ], “originalHtmlSelection”: “”, “htmlHighlight”: “”, “tag”: { “id”:
17592186045424, “name”: “Size”, “color”: “black”, “background”: “lime”,
“overwrite”: true, “properties”: [ { “id”: 17592186047928, “name”:
“value_type”, “values”: [“max”, “min”, “approximate”, “exact”] }, { “id”:
17592186045422, “name”: “unit”, “values”: [“dimension”, “sf”, “acre”] }, {
“id”: 17592186045423, “name”: “space”, “values”: [“1”, “2”] } ] }, “id”:
17592186252083 }, { “text”: “Free standing”, “offset”: 0, “overwrite_text”: “”,
“client_id”: 10, “length”: 13, “selected_properties”: [ { “id”: 17592186252112,
“name”: “space_type”, “value”: “building” }, { “id”: 17592186252113, “name”:
“space”, “value”: “1” } ], “originalHtmlSelection”: “”, “htmlHighlight”: “”,
“tag”: { “id”: 17592186045427, “name”: “Space_type”, “color”: “white”,
“background”: “maroon”, “overwrite”: true, “properties”: [ { “id”:
17592186045425, “name”: “space_type”, “values”: [“unit”, “parking_lot”,
“basement”, “other”, “lot”, “building”, “gla”, “office”] }, { “id”:
17592186045426, “name”: “space”, “values”: [“1”, “2”] } ] }, “id”:
17592186252084 }, { “text”: “fast food restaurant”, “offset”: 0,
“overwrite_text”: “”, “client_id”: 11, “length”: 20, “selected_properties”: [ {
“id”: 17592186252114, “name”: “listing_type”, “value”: “retail” } ],
“originalHtmlSelection”: “”, “htmlHighlight”: “”, “tag”: { “id”:
17592186045431, “name”: “Property_Type”, “color”: “white”, “background”:
“olive”, “overwrite”: true, “properties”: [ { “id”: 17592186045430, “name”:
“listing_type”, “values”: [“retail”, “land”, “other”, “multi-family”,
“industrial”, “office”] } ] }, “id”: 17592186252085 }, { “text”: “building”,
“offset”: 0, “overwrite_text”: “”, “client_id”: 12, “length”: 8,
“selected_properties”: [ { “id”: 17592186252116, “name”: “space”, “value”: “1”
}, { “id”: 17592186252115, “name”: “space_type”, “value”: “building” } ],
“originalHtmlSelection”: “”, “htmlHighlight”: “”, “tag”: { “id”:
17592186045427, “name”: “Space_type”, “color”: “white”, “background”: “maroon”,
“overwrite”: true, “properties”: [ { “id”: 17592186045425, “name”:
“space_type”, “values”: [“unit”, “parking_lot”, “basement”, “other”, “lot”,
“building”, “gla”, “office”] }, { “id”: 17592186045426, “name”: “space”,
“values”: [“1”, “2”] } ] }, “id”: 17592186252086 }, { “text”: “Nick”, “offset”:
0, “overwrite_text”: “”, “client_id”: 13, “length”: 13, “selected_properties”:
[ { “id”: 17592186252117, “name”: “broker_contact”, “value”: “1” } ],
“originalHtmlSelection”: “”, “htmlHighlight”: “”, “tag”: { “id”:
17592186045434, “name”: “Broker_Name”, “color”: “white”, “background”:
“purple”, “overwrite”: true, “properties”: [ { “id”: 17592186124601, “name”:
“broker_contact”, “values”: [“1”, “2”] } ] }, “id”: 17592186252087 }, { “text”:
“1.888.317.7721”, “offset”: 0, “overwrite_text”: “”, “client_id”: 14, “length”:
14, “selected_properties”: [ { “id”: 17592186252118, “name”: “broker_contact”,
“value”: “1” } ], “originalHtmlSelection”: “”, “htmlHighlight”: “”, “tag”: {
“id”: 17592186045435, “name”: “Broker_Phone”, “color”: “black”, “background”:
“red”, “overwrite”: true, “properties”: [ { “id”: 17592186124602, “name”:
“broker_contact”, “values”: [“1”, “2”] } ] }, “id”: 17592186252088 }, { “text”:
“nick @gmail.com”, “offset”: 0, “overwrite_text”: “”, “client_id”: 15,
“length”: 28, “selected_properties”: [ { “id”: 17592186252119, “name”:
“broker_contact”, “value”: “1” } ], “originalHtmlSelection”: “”,
“htmlHighlight”: “”, “tag”: { “id”: 17592186045436, “name”: “Broker_Email”,
“color”: “black”, “background”: “silver”, “overwrite”: true, “properties”: [ {
“id”: 17592186124603, “name”: “broker_contact”, “values”: [“1”, “2”] } ] },
“id”: 17592186252089 }, { “text”: “Banker Commercial”, “offset”: 0,
“overwrite_text”: “”, “client_id”: 16, “length”: 30, “selected_properties”: [ {
“id”: 17592186252120, “name”: “broker_contact”, “value”: “1” } ],
“originalHtmlSelection”: “”, “htmlHighlight”: “”, “tag”: { “id”:
17592186045437, “name”: “Broker_Company”, “color”: “white”, “background”:
“teal”, “overwrite”: true, “properties”: [ { “id”: 17592186124604, “name”:
“broker_contact”, “values”: [“1”, “2”] } ] }, “id”: 17592186252090 }, { “text”:
“For Sale or Lease”, “offset”: 0, “overwrite_text”: “”, “client_id”: 17,
“length”: 17, “selected_properties”: [ { “id”: 17592186252121, “name”:
“transaction_type”, “value”: “sale or lease” } ], “originalHtmlSelection”: “”,
“htmlHighlight”: “”, “tag”: { “id”: 17592186045429, “name”: “Transaction_Type”,
“color”: “white”, “background”: “navy”, “overwrite”: true, “properties”: [ {
“id”: 17592186045428, “name”: “transaction_type”, “values”: [“sale”,
“investment”, “sale or lease”, “lease”] } ] }, “id”: 17592186252091 }, { “id”:
17592186252092, “client_id”: 18, “offset”: 0, “length”: 21, “tag”: { “id”:
17592186045418, “name”: “Street”, “color”: “black”, “background”: “aqua”,
“overwrite”: true }, “text”: “1631 N. Mannheim Road”, “overwrite_text”: “”,
“originalHtmlSelection”: “”, “htmlHighlight”: “” }, { “id”: 17592186252093,
“client_id”: 19, “offset”: 0, “length”: 10, “tag”: { “id”: 17592186045419,
“name”: “City”, “color”: “white”, “background”: “blue”, “overwrite”: true },
“text”: “Stone Park”, “overwrite_text”: “”, “originalHtmlSelection”: “”,
“htmlHighlight”: “” }, { “id”: 17592186252094, “client_id”: 20, “offset”: 0,
“length”: 8, “tag”: { “id”: 17592186045420, “name”: “State”, “color”: “black”,
“background”: “fuchsia”, “overwrite”: true }, “text”: “Illinois”,
“overwrite_text”: “IL”, “originalHtmlSelection”: “”, “htmlHighlight”: “” }, {
“text”: “Nick”, “offset”: 0, “overwrite_text”: “”, “client_id”: 21, “length”:
13, “selected_properties”: [ { “id”: 17592186252122, “name”: “broker_contact”,
“value”: “1” } ], “originalHtmlSelection”: “”, “htmlHighlight”: “”, “tag”: {
“id”: 17592186045434, “name”: “Broker_Name”, “color”: “white”, “background”:
“purple”, “overwrite”: true, “properties”: [ { “id”: 17592186124601, “name”:
“broker_contact”, “values”: [“1”, “2”] } ] }, “id”: 17592186252095 }, { “text”:
“ Banker Commercial “, “offset”: 0, “overwrite_text”: “”, “client_id”: 22,
“length”: 30, “selected_properties”: [ { “id”: 17592186252123, “name”:
“broker_contact”, “value”: “1” } ], “originalHtmlSelection”: “”,
“htmlHighlight”: “”, “tag”: { “id”: 17592186045437, “name”: “Broker_Company”,
“color”: “white”, “background”: “teal”, “overwrite”: true, “properties”: [ {
“id”: 17592186124604, “name”: “broker_contact”, “values”: [“1”, “2”] } ] },
“id”: 17592186252096 } ] } ], “originalDocumentWithAnnotations”: “\n\n\n\n\n\n
\n \n \n\n\n\n\n
\n
Free Standing Fast Food Restaurant
\n
Free Standing Fast Food Restaurant
\n
with Drive
\n
with Drive--Thru
\n
Thru
\n
Property Highlights
\n
\n
??
\n
Building size: 2,500 SF
\n
??
\n
Lot size: 100x141 or 14,100 SF
\n
??
\n
Free standing fast food restaurant with drivethru
\n
??
\n
New constructionbrick building
\n
??
\n
Price: $499,500 or lease $16 per SF NNN
\n
??
\n
Zoned: B3
\n
??
\n
Real Estate Taxes: 24,000 +/
\n
1631 N. Mannheim Road, Stone Park, Illinois
\n
For Sale or Lease
\n
Bank Owned
\n
Demographics
\n
1 Mile
\n
3 Miles
\n
5 Miles
\n
Population
\n
12,458
\n
112,199
\n
294,527
\n
Avg. HH Income
\n
$50,430
\n
$64,739
\n
$79,664
\n
Source: Loopnet
\n
For More Information, Contact
\n
Nick
\n
\n\n\n
\n
For Sale or Lease
\n\n\n”, “assignment_id”: 17592186163742, “id”: 89060}

FIG. 2A shows a logic flow diagram illustrating annotation tool embodiments of the MLDA. In one embodiment, the MLDA server may receive an initial data set from a data supplier 201. In one embodiment, the initial data set may be a real estate property data set. The training data may be in any structured or non-structured data format (e.g., pdf, email, SMS, audio, video, etc.). The MLDA may receive initial rules from a rules supplier 205 and store the initial data set and rules to the database 210. Upon receiving a request for review from a training user 212, the MLDA may retrieve data for processing and rules for updating 215. The MLDA may parse the data and process the parsed data with rules and the Annotation Tool component, and highlight discerned document parts 220, via tools such as, but not limited to GWT, Datomic database, and/or the like.

In one embodiment, the initial data set files, which may be PDF files, are converted to HTML versions 221. A pdf to html Library may be used to achieve the conversion. Additional libraries, such as IDR solutions may be also used. The HTML version of the initial data set file may be then displayed on a web interface (radmin) 222. The Radmin web application provides highlighting functionality. Data entry staff may highlight text and press one of a (configurable) set of buttons referring to different fields (e.g. Property Size, Transaction Type, etc.). Additional field attributes can also be provided via the web interface (e.g. drop downs and free text referring to individual highlights). To output the results from Machine Learning, the text in the document can be similarly highlighted and the actual extracted listing information appears in an editable web form next to the initial data set file 290.

In one embodiment, additional features such as the relative position of the text in the rendered HTML document; words matching a list of broker companies and emails, etc., may also be included.

The MLDA may extract data fields within the document 223. The MLDA may further populate web form with extracted results and generate a web page for display 225 and provide the highlighted document for display and review 228. Upon receiving an input 230 from a training user and/or its client device to correct the highlights 235, the MLDA may process the inputs as new training data 235 and feed to the Annotation Tool component 240. In one implementation, when a single new training data document is generated, it may be fed to the Annotation Tool component one at a time. In another implementation, multiple new training data documents may be fed to the Annotation Tool component at the same time. The MLDA may generate and/or update machine learning model 245 using artificial intelligence machine learning technique via tools such as but not limited to: LibSVM, Gate, Apache UIMA, Apache OpenNLP, and/or the like. In one implementation, the machine learning model may be updated every time a single new training data document is fed to the Annotation Tool component. In another implementation, the machine learning model may be updated after multiple new training data documents are fed to the Annotation Tool component. The MLDA may further store the new training data and the generated and/or updated machine learning model to the database 255.

FIGS. 2B-2J show example Radmin tool to text annotation in some embodiments of the MLDA. In one embodiment, the Radmin tool user interface may be linguistic annotation of text with a list of pre-defined categories. Users may be assigned a set of documents and their task is to select text that refers to a set of categories: e.g. listing address, broker name/phone/email, company, sf, etc. These selections are then used as input to a Machine Learning algorithm. The purpose of this type of annotation may be to identify text snippets containing particular type of information, e.g. “street address”, “city address”, “square footage”, etc. For example, the text snippet shown below contains one “street address” annotation (yellow) and one “city address” annotation (green): For example,

Vintage Harvest - 16108 S. Rt 59, Plainfield, IL [Community

Shopping Center]

| | |
|---|---|
| • | Co-tenancy: New Italian Fine Dining, Center Pointe |

Church, Reptile Store, Meat Store, Spirit Clothing Warehouse, Hometown
Fitness, Encore Theater, & Live 59.

| | |
|---|---|
| • | Anchored by Burger King and Light Source Lighting |
| • | High traffic count along Rt. 59 - 48,200 vehicles per day |
| • | Strong Demographics: 60,000+ within 3 miles |
| • | Available Units: 1,050sf, 1200sf, 1440sf, & 1440sf |

Users may be presented with a list of documents assigned to him for annotation as shown in FIG. 2B. “Incomplete” documents are shown. Selecting “Show All Documents” may also show previously completed documents (with status complete), or documents that were skipped. After the user select a document by clicking on the flyer's link, the document opens as shown in FIG. 2C. User's task is to read carefully the original document (left pane) and annotate all relevant listing information. Annotation is performed by selecting text and then clicking on one of the color-coded categories shown on top (Street, State, City, Zip, etc). The annotations are then added to the Listings pane on the right. Occasionally documents contain more than one listing. To create additional listings, click on the “New listing” button in the right pane. Annotations may be then added to the currently selected listing (in green), as shown in FIG. 2D. Both annotations and listings can be deleted by clicking on the red X button next to them. Deleting a listing will also delete all previously created annotations for the listing. Occasionally, corrections or modifications of the text selections are necessary for the purpose of collecting accurate data. For example, the document can contain typos or abbreviations that need to be expanded, etc. To overwrite (i.e. correct) the value of an annotation click on the [edit+] button next to the annotation. A text field will be shown where you can enter the corrected text, as shown in FIG. 2E. Certain annotation categories contain additional information shown in a dropdown. For example, “Property_type” retail could refer to text such as restaurant, gym, etc. In such cases the annotated text need to be categorized as “Retail” as shown in FIG. 2F. Listings can contain multiple “spaces”. For example, a shopping mall can have multiple individual spaces for lease. Annotation types that belong to spaces contain a “space” drop down. For example “Size” annotations belong to a particular space. To create multiple spaces use the “New Space” bottom right. FIG. 2G shows a sample listing with 2 spaces. information may be saved when the “Save” button is clicked. Once the document is annotated in full and all listings/spaces have been properly created, the “Complete” button marks the document as “complete” and loads the next document from the work queue.

In some embodiments, one may only need to annotate keywords that are relevant to the property being offered. One may select the smallest piece of text relevant to a particular piece of information, excluding surrounding punctuation if any. Whenever the selected text does not reflect accurately the specific piece of information, one may use the overwrite text field ([edit+]) to make any corrections. Details for each of the available tags are below:

### Street:

Please select the text describing the street address of the listing. If multiple street addresses are available in the document (e.g. street number, street intersection, repetitions of the address) please enter ALL of them as separate annotations. Please include nearby intersections if mentioned. For example, “Near the Intersection of Stevens Creek Blvd./West St”. Please include Suite, apartment number if any, or the corner (e.g. NWC: northwest corner) of street intersections. Please make sure only the property street address is selected. Do NOT select the street address of the broker company. If only the street name is shown later in the flyer, please annotate it, even if the full address (complete with street number and street name) was annotated previously in the flyer.

### State:

Please select the text describing the state of the listing address. If multiple state instances are available in the document (e.g. repetitions of the address) please enter ALL of them as separate annotations. If the state is written out as the full name, please search for the state abbreviation, click the [edit+] button, and enter the state abbreviation. Please do not annotate the state given for the broker or broker company listed.

### City:

Please select the text describing the city of the listing. If multiple instances are available in the document (e.g. repetitions of the address) please enter ALL of them as separate annotations. Please do not annotate the city given for the broker or broker company listed.

### Neighborhood:

Please select the text describing the neighborhood or the general area of the listing, if available. If multiple instances are available in the document (e.g. repetitions of the address) please enter ALL of them as separate annotations. Neighborhood can include text describing the suburbs.

### Zip:

Please select the text describing the zip code of the listing. If multiple instances are available in the document (e.g. repetitions of the address) please enter ALL of them as separate annotations. Please include all zip code digits, including 9-digit zip codes (e.g. 60606-1235). Please do not annotate the zipcode given for the broker or broker company listed.

### Size:

A listing can contain more than one size descriptor. For example, a shopping mall can contain multiple units for lease, or a property can list the total lot size, building size, GLA (gross leasable area), etc. Please select EACH size instance and annotate it with different space numbers. An example is shown in FIG. 2H.

Please select the size including the unit with the text that follows (square feet/acres/dimension e.g. 100×300 feet) if available. For example, if a size is 2,050 square feet, please annotate “2,050 square feet” rather than the number “2,050” alone. The following example shows a correctly annotated size: . . . new 240,000 SF medical center . . . . Similarly, the selection should include the size unit even if preceded by other characters, the most common characters being +/− . . . 22,376+/−sq. ft. . . . After annotating a size, you will need to select from the drop-down box either (sf, dimension, or acres) for the size. Sometimes the unit type is explicitly listed, however, occasionally it needs to be inferred. For example 240,000 unit type must refer to SF even if not specified explicitly, as 240,000 acres is the equivalent of 181,818 football fields (1.32 acres=1 football field). In addition, various sizes can refer to the same “SPACE”, for example a building for sale can list the lot size and the building size as separate sizes. Alternatively, sizes can refer to different spaces. A shopping mall can contain multiple spaces, each with its own square feet. To indicate the space that each size refers to use the “space” dropdown. It defaults to “Space 1”. If there is only one space described in the document with various sizes, please select “1” for all of them. For multiple spaces, please use the “New Space” button. The button will add additional spaces to the space dropdown: 1, 2, 3, etc. Please make sure that all sizes referring the same space have the same space number selected. It does not matter which number it is, we just need to group the information into spaces. Lastly, select the size value property as min, max, exact, or approximate. Spaces can be given as min/max values, exact space size, or approximate size. If a flyer states “up to 5,000 sq ft”, then “5,000 sq ft” would be listed as the max. If the flyer says “from 960 sq ft to 1,400 sq ft”, then “960 sq ft” would be the min, and “1,400 sq ft” would be the max. Sometimes, a size or multiple sizes are given that are irrelevant or don't refer to the actual property, such as “ceiling heights” or “overhead door” sizes. In these cases, please do not annotate the sizes given. The general rule to remember is that if the size doesn't refer to or correspond with the property's space type(s), then it shouldn't be annotated.

### Confidential Listing:

Select any text that leads you to the conclusion that this is a confidential listing. This could be explicitly mentioned, e.g. the word “confidential” will appear, in which case select the word or phrase that refers to it. Alternatively, the address can be listed as “9999 confidential street”, in which case select the address and annotate it as “confidential listing”. Confidential listings are listings with undisclosed address or explicitly marked as confidential. Occasionally, the flyer can contain statements such as “confidentiality agreement required before disclosure of details”.

### Broker Name:

Select the name of each broker representing the listing. If the name appears multiple times, select EACH instance and annotate it. When there are multiple brokers, please click the “new contact” button and change the drop-down menu so that each individual broker has their own broker_contact number. An example is shown in FIG. 2I.

### Broker Phone:

Select each instance of a phone number for the broker including the phone number description (cell, office, etc). For example, include “Cell:” when selecting the following phone number “ . . . Cell: 815 739 xxxx . . . .” If there are two or more phone numbers listed for the broker, for example cell: 555-555-5555 and office 555-555-5555, please annotate both numbers as the broker's phone, and use the same broker_contact number in the drop-down menu. Please also include any phone extensions.

### Broker Email:

Select each instance of the broker email.

### Broker Company:

Select each instance of the broker company, excluding the company URL. In case when the company department or division is shown, select the minimum text that identifies the company. For example, select MEACHAM/OPPENHEIMER, INC., excluding COMMERCIAL BROKERAGE INVESTMENT SALES:

### MEACHAM/OPPENHEIMER, INC.

### COMMERCIAL BROKERAGE

### INVESTMENT SALES

Please include the company type, eg. Inc, LLC, etc. if present.

### Company Website:

Select each instance of the broker company website.

### Company Phone:

Select each instance of the broker company phone. In some cases, this can coincide with the Broker Phone. In this case, select the same phone twice and tag it once as Broker Phone, and once as Company Phone. If the company phone number has something in front of it, for example “(ph)” or “phone”, please also annotate these words with the phone number. Please also include any phone extensions.

### Space Type:

Space type refers to specified space or listing sizes. It refers to text describing the space type, e.g. UNIT, GLA, LOT, Parking LOT, BUILDING SIZE, etc. The space type will almost always have a corresponding size. Select the text referring to the size types, tag it as “space_type”, and select the appropriate type from the dropdown. An example is shown in FIG. 2J.

Make sure that the space type refers to the same space as the corresponding size. Again, the space number is just a sequential number, it is just used to group annotations into spaces. In some cases, the space type (Building, lot, GLA) is not mentioned explicitly. If no explicit mention is available, select the text that made you guess the space type. For example, “5,000 sf with basement” is space type “building”. Since there is no explicit mention of building, select “with basement” for space_type since this is what made you conclude this size refers to a building. Space type is the category that simply gives more detail to the “Size” category and explains what the “Size” category is describing. Space type explains what the actual structure is. If the space type isn't relevant to the property, please do not annotate it. The most common space types are Building, Unit, and Lot. Examples of each of these are listed below.
Unit: Unit, Suite, Warehouse, or any other keyword that has a size next to it that is INSIDE of an actual building.
Parking Lot: Parking Lot (NOT just “lot”, must say “parking lot”)
Basement: Basement
Other: Use only if there is a size available and it doesn't fall into other space type categories, then highlight whatever word that the size is describing
Lot: Lot, Land Area, Land Size, Tract, Pad (If there is a size for the pad, then “pad” would become the space type. If not, then “pad” would be property type.)
Building: Building, Freestanding, Stand-alone, Warehouse (this is usually only when the word “building” is not available).
Gla: Describes a size type that says it's the gross leasable area, or gla. Keywords would be gla or gross leasable area (or gross whatever area)
Office: Office (this is usually used when a size is being described inside of a building, for example: there is a 4,000 sq ft building, with 1,050 sq ft of office. If there is a size for the office, then office would become the space type. If not, then office would be property type.)
   In some cases, space type keywords are mentioned but do not refer to the property space type that is being offered in the flyer. In this case DO NOT annotate them. For example:

### [Restaurant] Located on the out lot of Lakeview Plaza in Orland Park, Ill.

Here “lot” does not refer to space type, so it shouldn't be annotated.

Transaction Type:

Select each instance of each individual piece of text referring to the transaction type of this listing. “For lease”, “For sale”, and “For sale or lease” are the most common transaction types. For example the word “sublet”, indicates a transaction type “Sale”. There can be multiple transaction types per listing. In addition, the same transaction type can be mentioned multiple times in the document. Select EACH instance and tag appropriately. Transaction type investment can be inferred by text such as “CAP rate”, in this case select the text that made you conclude that this is an investment property and mark it as “investment”.

### Property Type:

Select each instance of each individual piece of text referring to the property type of this listing. Property type describes what the business is. For example the word “restaurant”, indicates a property type “Retail”. Please avoid using plural words as the property type, for example the words “restaurants” or “offices”. There can be multiple property types per listing. In addition, the same property type can be mentioned multiple times in the document. Select EACH instance and tag appropriately. The most common property types are Retail, Office, Industrial, Land. Examples of each of these are listed below.
Industrial: Flex Space, Industrial-Business Park, Industrial Condo, Manufacturing, Office Showroom, R&D, R and D, Research and Development, Self/Mini-Storage Facility, Self-Storage Facility, Mini-Storage Facility, Truck Terminal, Truck Hub, Truck Transit, Warehouse, Distribution Warehouse, Refrigerated/Cold Storage, Cold Storage, Refrigerated Storage, Industrial Park, Industrial
Land: Industrial (land), Multifamily (land), Office (land), Residential (land), Retail (land), Retail-Pad (land), Commercial/Other (land), Leased Land, Land, Development Site, Pad
Multifamily*: Government Subsidized, Mid/High-Rise, Mobile Home/RV Community, Duplex/Triplex/Fourplex, Garden/Low-Rise, Garden, Low-Rise, Government Subsidized, Mid-Rise, High-Rise, Mobile Home, RV Community, Duplex, Triplex, Fourplex, Multifamily, Apartment Community
Office: Office Building, Institutional/Governmental, Office-Business Park, Office-R&D, Office-R and D, Office-Research and Development, Office-Warehouse, Office Condo, Creative/Loft, Medical Office, Office Complex, Office
Retail: Community Center, Strip Center, Retail Strip, Neighborhood Center, Outlet Center, Power Center, Regional Center/Mall, Regional Center, Regional Mall, Mall, Super Regional Center, Specialty Center, Theme/Festival Center, Theme Center, Festival Center, Anchor, Restaurant, Service/Gas Station, Service Station, Gas Station, Retail Pad, Street Retail, Day Care Facility/Nursery, Day Care Facility, Nursery, Post Office, Vehicle Related, Retail (Other), Retail Space, Retail, Diner, Nightclub, Bar and Grill, Bar, Tavern
Commercial Other: None of the categories described above.
   Please include the full phrase describing the property type, for example, highlight the full phrase “fast food restaurant”, not just “restaurant”.
   Please include all phrases that unambiguously suggest the property type. Exclude phrases that can be ambiguous, for example “drive thru” can refer to retail, but also banking, etc. so do not mark it as “property type—>retail”.
   Barely visible text: In some cases, overlaid text can be barely visible. For example “427 & 447 S. BASCOM AVENUE, SAN JOSE, . . . ” below:
   Please try to annotate the text in such cases. As a rule of thumb, if the text is selectable, and visible after highlighting, please annotate it.

### Known Issues:

Please use the Chrome web browser to annotate documents as this is the only tested browser. Please DO NOT highlight overlapping text as this is a known issue with the annotation application. For example, consider the text “medical office”. If you first highlight the text “office” (“medical office”), and subsequently highlight the overlapping text “medical office” the application breaks. Subsequently, deleting of the annotations also does not work. Sometimes overlapping annotations can be introduced by using the checkbox “Highlight Matches”, or a combination of using “Highlight Matches” and the attempting to manually annotate the same word or phrase. If this happens please DO NOT save the document and revert the changes by refreshing the page.
Sometimes using the “Highlight Matches” button can cause issues within Radmin. It is important to remember that some of the keywords found in the flyers may not be relevant to the property and therefore should not be annotated. In cases such as these, including categories such as the City or State, “Highlight Matches” should not be used. It is important to look through the flyer before annotating and decide which categories are best suited for using the “Highlight Matches” button.
If left inactive for more than an hour, the backend of the Radmin system will go to “sleep” and takes a few minutes to come back up. This means that if a flyer is left open and inactive on your computer for about an hour, and then you return to annotating, you will most likely experience issues or bugs. If you take any breaks or stop working for a while, you should always make sure to refresh the page before you resume annotating.

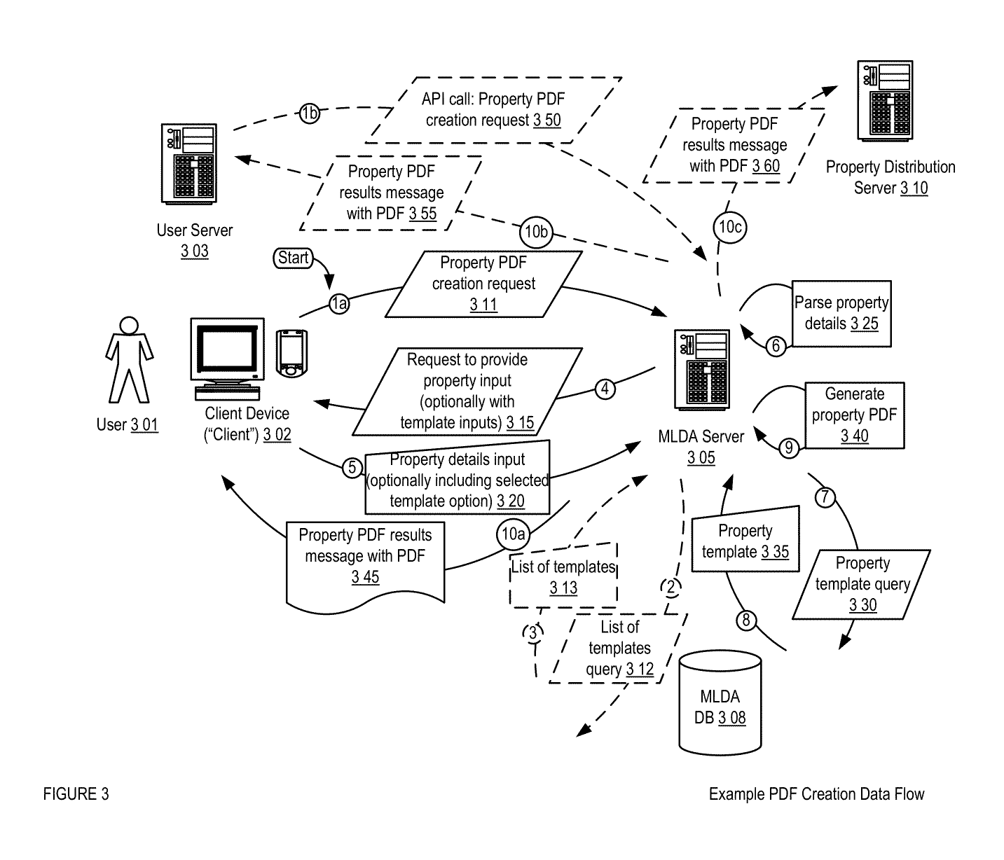

FIG. 3 shows a block diagram illustrating PDF creation embodiments of the MLDA. In one embodiment, a MLDA user may desire to create a PDF flyer. If the user is a broker agent or broker firm, it may desire to create a PDF flyer about the property. If the user is a merchant, it may desire to create a PDF flyer about the product. In one embodiment, the user 301 and/or the client device (e.g., computer, mobile device, etc.) 302 may send 311a property (and/or other type of products/services) PDF creation request to the MLDA server 305. For example, a browser application executing on the user's client may provide, on behalf of the user, a (Secure) Hypertext Transfer Protocol (“HTTP(S)”) GET message including the request details for the MLDA server in the form of data formatted according to the eXtensible Markup Language (“XML”). Below is an example HTTP(S) GET message including an XML-formatted property PDF creation request 311 for the MLDA server:

GET /propertyPDFcreationrequest.php HTTP/1.1
Host: www.MLDA.com
Content-Type: Application/XML
Content-Length: 1306
<?XML version = “1.0” encoding = “UTF-8”?>
<property_PDF_creation_request>

<timestamp>2001-02-22 15:22:43</timestamp>
<user_ID>4NFU4RG94</user_ID>
<user_name>JohnSmith</user_name>
<user_email>jsmith@pdfcreation.net</user_email>
<industry_id>real estate</industry_id>

</property_PDF_creation_request>

In one implementation, the MLDA may optionally send a list of templates query 312 to the MLDA database 308. The MLDA database may provide a list of templates upon such query 313. The MLDA may then send a request to the user/client to provide property input 315, and optionally with the request to select one from the list of templates. The user may provide the property details input 320 to the MLDA, and optionally including selected template option. For example, a browser application executing on the user's client may provide, on behalf of the user, a (Secure) Hypertext Transfer Protocol (“HTTP(S)”) GET message including the property details for the MLDA server in the form of data formatted according to the eXtensible Markup Language (“XML”). Below is an example HTTP(S) GET message including an XML-formatted property details input 320 for the MLDA server:

GET /propertydetailsinput.php HTTP/1.1
Host: www.MLDA.com
Content-Type: Application/XML
Content-Length: 1306
<?XML version = “1.0” encoding = “UTF-8”?>
<property_details>

<timestamp>2001-02-22 15:22:43</timestamp>
<user_ID>4NFU4RG94</user_ID>
<user_name>JohnSmith</user_name>
<user_email>jsmith@pdfcreation.net</user_email>
<industry_id>real estate</industry_id>
<property_type>commercial</property_type>
<property_photo>attachment</property_photo>
<property_location>111 Peach St, Baltimore, MD

10001</property_location>

<property_description>Amazing Retail Space in Downtown

Baltimore</property_description>

<property_status>Sale</property_status>
<property_size>18000 square feet</property_size>
<property_availability>2005-01-01</property_availability>
<property_additional_attachment>attachment

YES</property_additional_attachment>

<property_contact_information>Real Estate Company 109

Prince St, Baltimore, MD 10002 Telephone (123) 456
6789</property_contact_information>
<option>

<template_ID>Pink ribbons</template_ID>

</option>
</property_details>

The MLDA server may parse the property details 325 and obtain different value fields such as property location, property details, property picture, and/or the like. The MLDA may send 330 a property template query to the database 308, and retrieve the property template 335. For example, an XML data file may be structured similar to the example XML data structure template provided below:

<?XML version = “1.0” encoding = “UTF-8”?>
<property_template_data>

<industry_id></industry_id>
<property_type></property_type>
<property_photo></property_photo>
<property_photo_placement></property_photo_placement >
<property_location></property_location>
<property_location_placement
></property_location_placement >
<property_description></property_description>
<property_description_placement
></property_description_placement >
<property_status> </property_status>
<property_status_placement > </property_status_placement >
<property_size> </property_size>
<property_size_placement > </property_size_placement >
<property_availability></property_availability>
<property_availability_placement
></property_availability_placement >
<property_additional_attachment>
</property_additional_attachment>
<property_additional_attachment_placement >

</property_additional_attachment_placement >

<property_contact_information></property_contact_information>
<property_contact_information_placement

></property_contact_information_placement >
</property_template_data>

The MLDA may then generate a property PDF flyer 340 according to the details the user provided and the property template. The MLDA may send the property PDF results message together with the PDF flyer back to the user/client 345. Alternatively, the property PDF creation request 350 may be sent from a user server 303 through API calls, and the property PDF results message together with the PDF flyer 355 may be sent back to the user server.

In one embodiment, the PDF creator tool may be used in property creator industry. In another embodiment, the PDF creator tool may also be contemplated in lease creator industry.

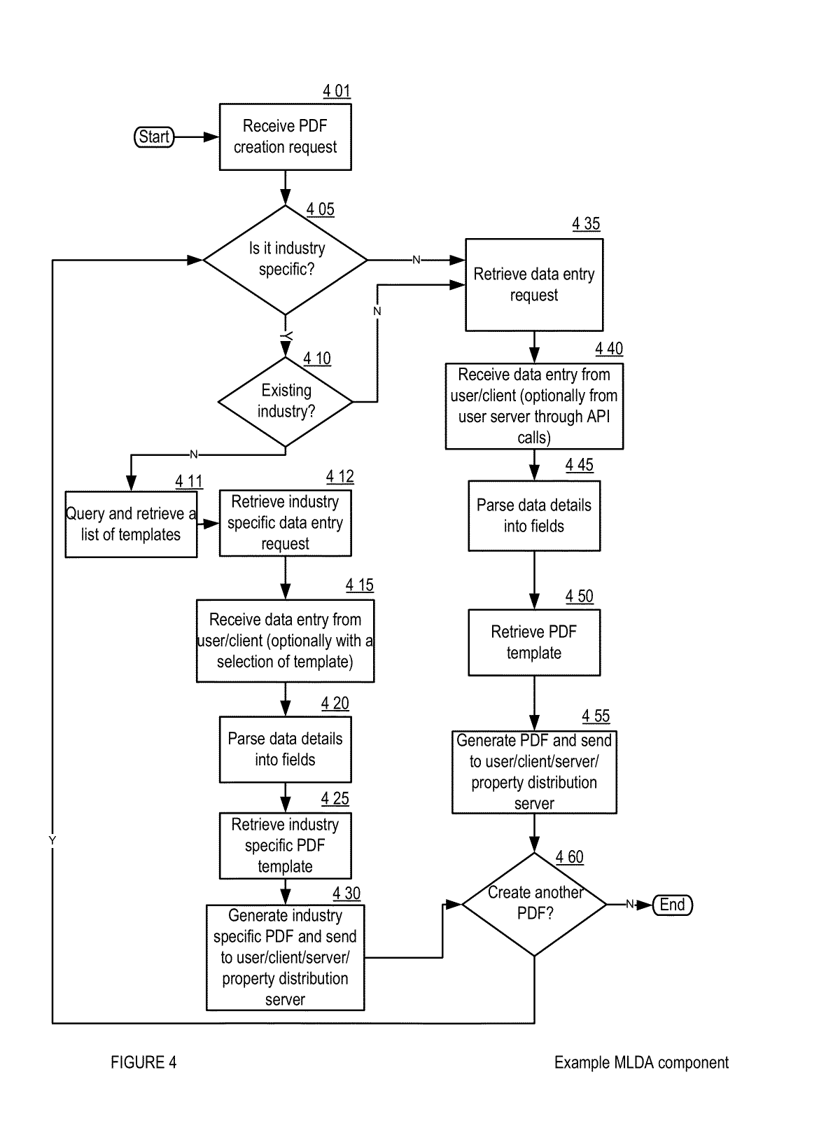

FIG. 4 shows a logic flow diagram illustrating PDF creation embodiments of the MLDA. In one embodiment, the MLDA server may receive a PDF creation request 401. The MLDA may determine if the request is industry specific 405. If it is industry specific (e.g., specific to real estate industry), the MLDA may further check if the industry is existing industry type in the database 410. If it exists, the MLDA may query the database and retrieve a list of templates for the user to select from 411. The MLDA may retrieve industry specific data entry request 412 and send to user/client. Upon receiving data entry (optionally including a selection of template) from user/client, or optionally from user server through API calls 415, the MLDA may parse data details into value fields 420. The MLDA may retrieve industry specific PDF template 425 from database, and generate an industry specific PDF flyer and send to user/client/user server and optionally to a property distribution server 430. If the MLDA receive another PDF creation request 460, the MLDA may start the process from 405. If the PDF creation request is not industry specific 405, the MLDA may retrieve data entry request form 435 and send to user/client/user server. Upon receiving data entry details from user/client (optionally from user server through API calls) 440, the MLDA may parse data details into value fields 445. The MLDA may retrieve PDF template 450 from database, and generate a PDF flyer and send to user/client/user server and optionally to a property distribution server 455. If the MLDA receive another PDF creation request 460, the MLDA may start the process from 405.

In one embodiment, this PDF creator tool may be used in a property creator industry. In another embodiment, the PDF creator tool may be applied equally for lease creator, and/or other industry PDF creator tools.

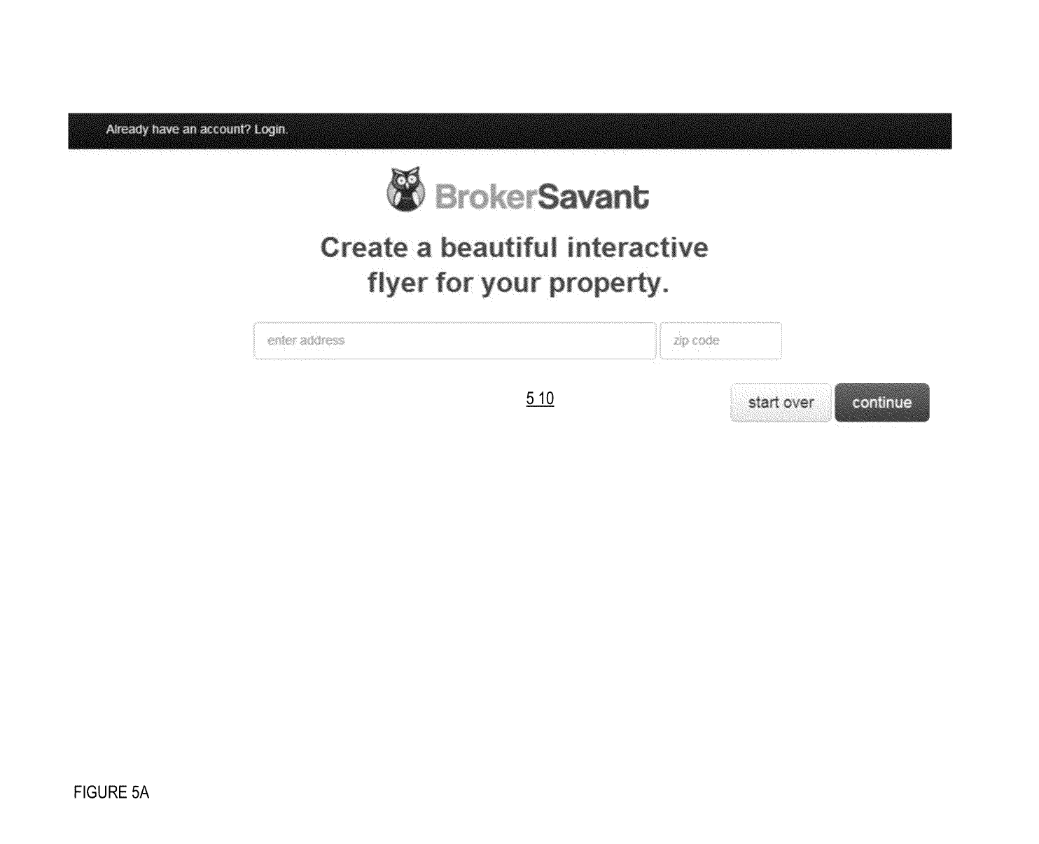

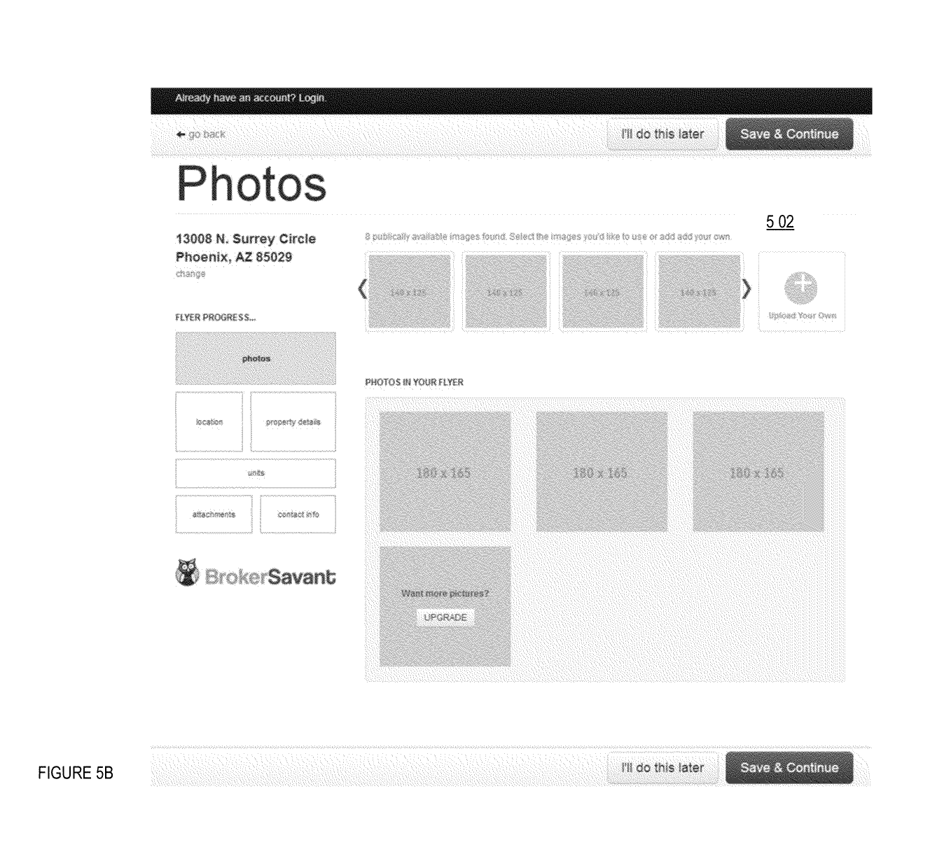

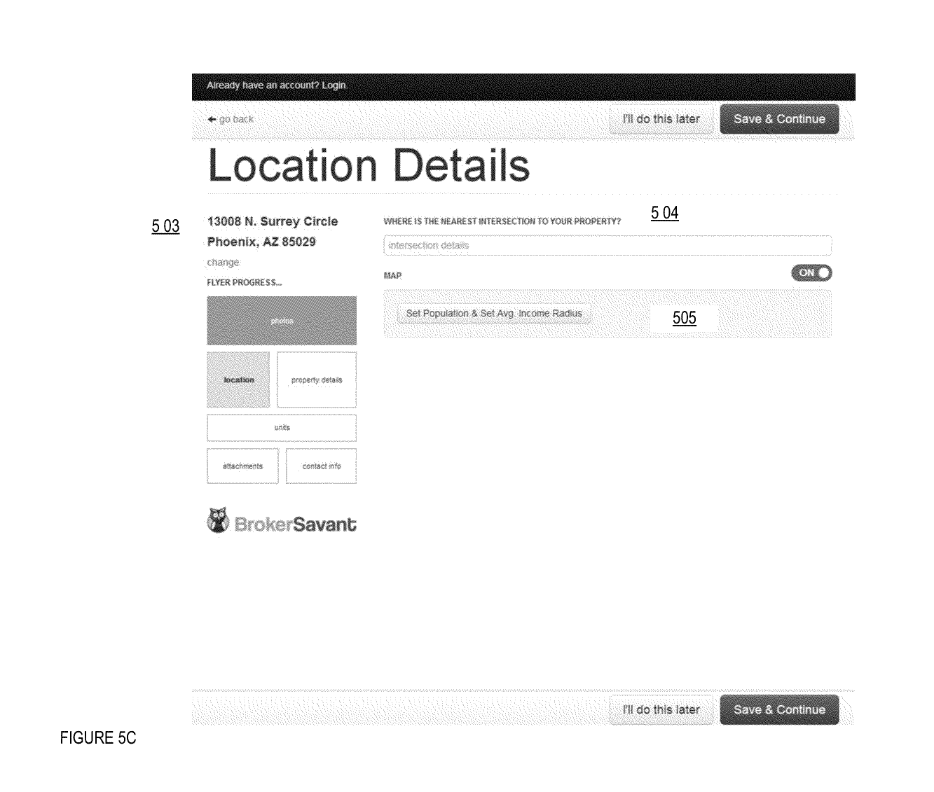

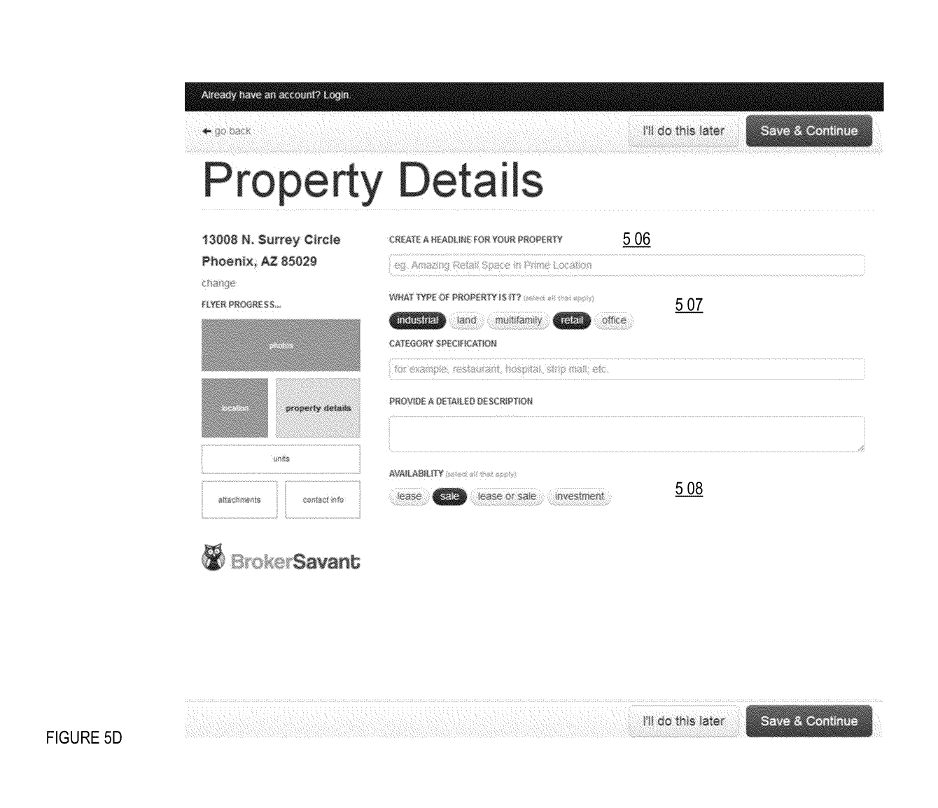

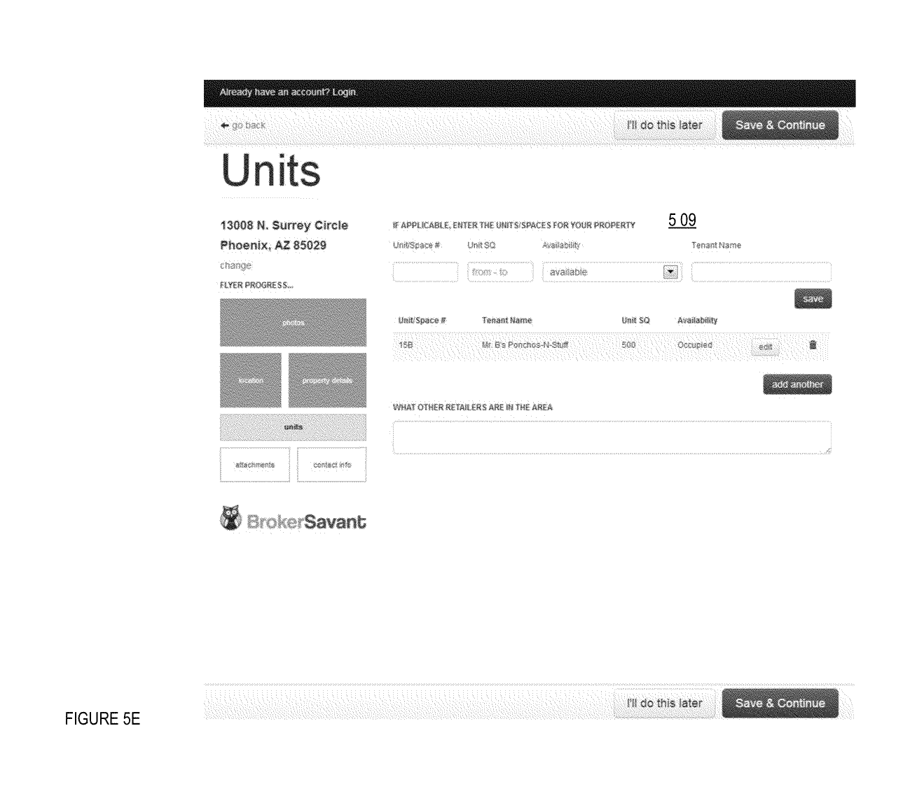

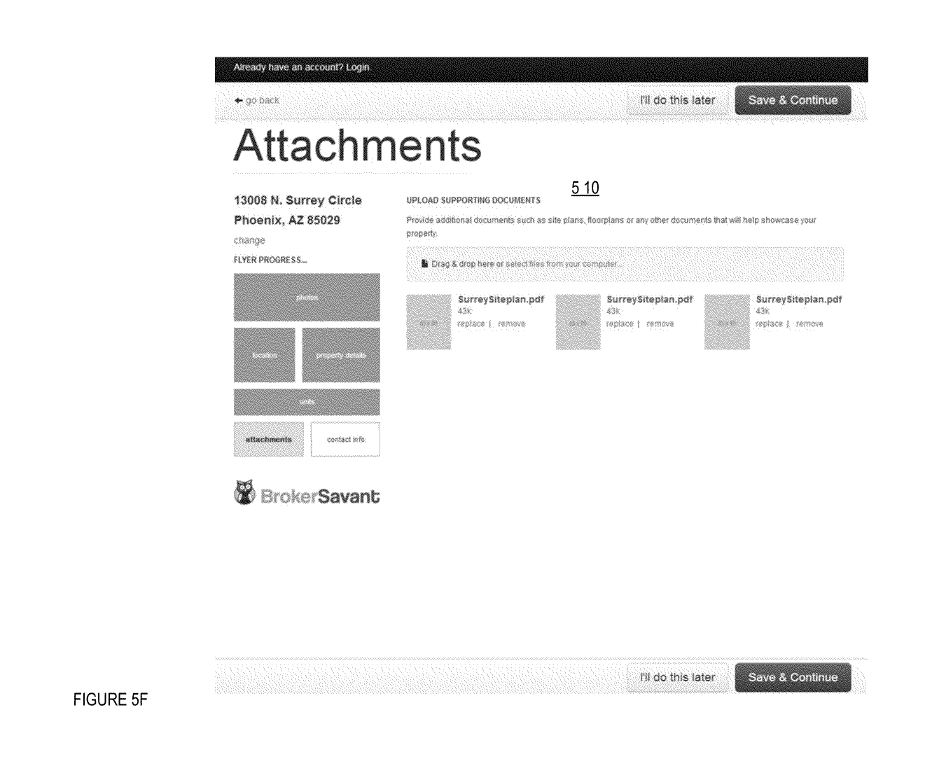

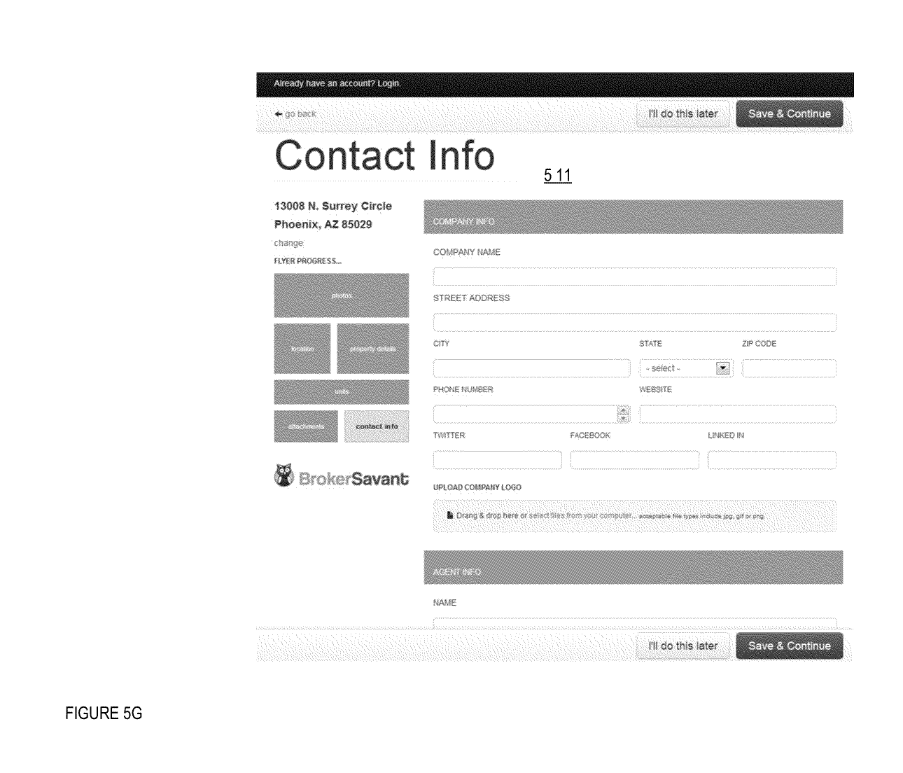

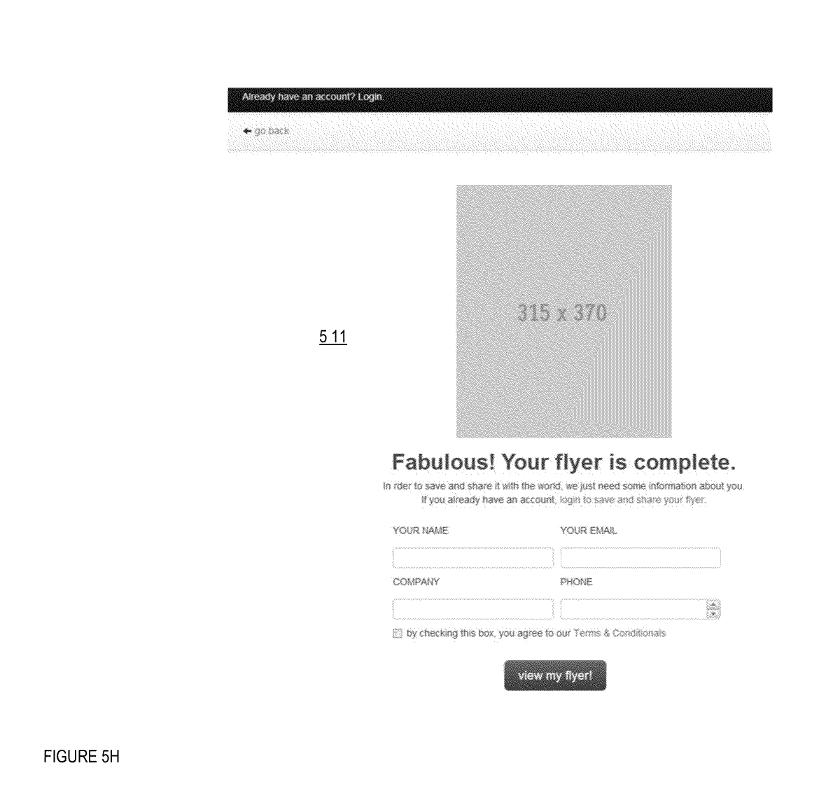

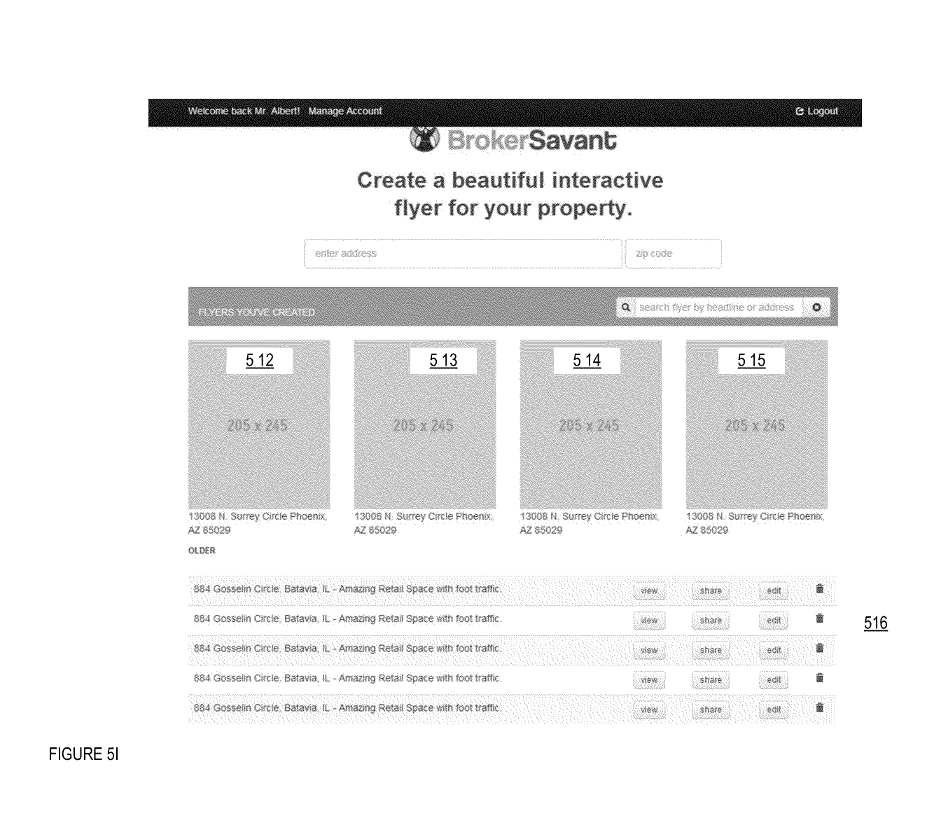

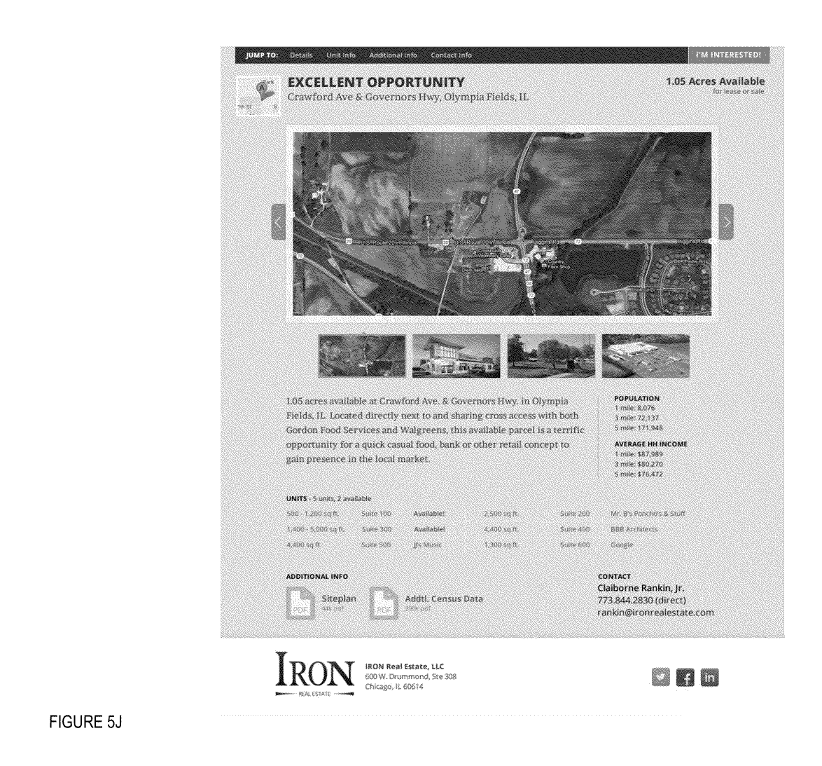

FIGS. 5A-5I show examples of PDF creation user interface in some embodiments of the MLDA. In some embodiments, a user may the MLDA PDF creation user interface to create their own flyer for a property. For example, the user may start by entering the email address and zip code 501. The user may choose to select an image(s) to display on the flyer from an existing MLDA database, or the user's own image library 502. The user may also manually enter more data or choose to let the MLDA server auto-complete flyer information based on the property address 503. The user may input the nearest intersection to your property 504, and select a map associated with the property 505. Other details about the property may be entered by the user, such as a headline of the property 506, a property type 507, availability of the property 508, unit/space details 509, and/or the like. The user may also associate other documents to be included into the flyer 510, such as a property site plan. The user may further enter the contact information 510 such as the realtor's company information. A complete property flyer may be created for the user 511. Once logged in, the user may also view all the flyers (e.g., 512, 513, 514, 515) created with the MLDA. The user interface may also allow the user to manage, edit, delete the flyers associated with the user 516.

FIG. 5J shows an example MLDA-created property PDF flyer in some embodiments of the MLDA. In one implementation, the property PDF results message together with the PDF flyer 360 may be sent to a property distribution server 310 for further distribution.

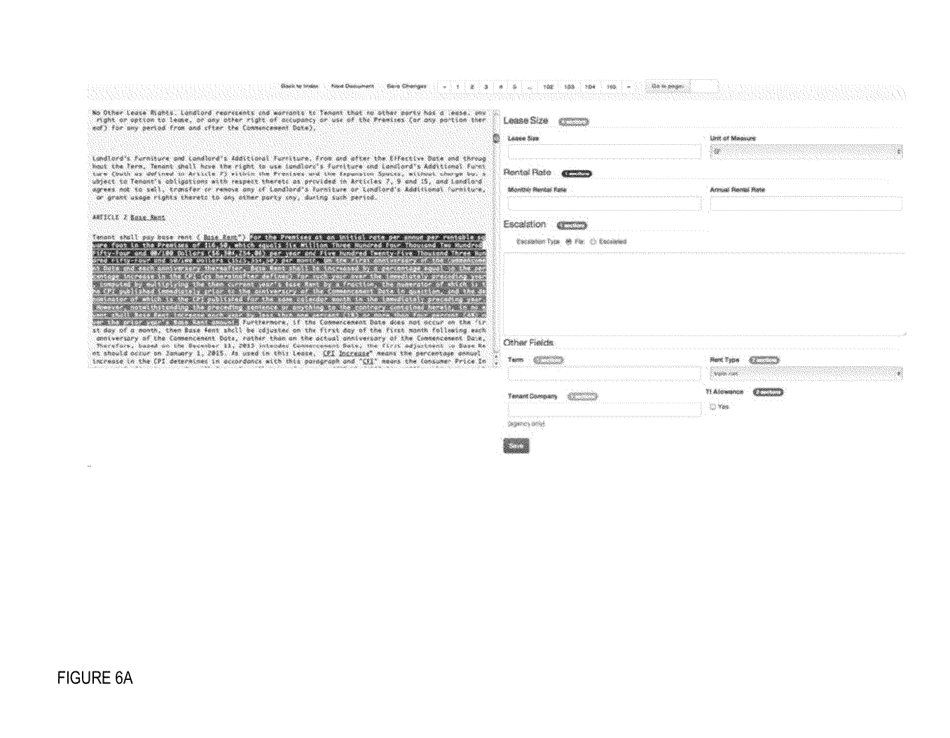

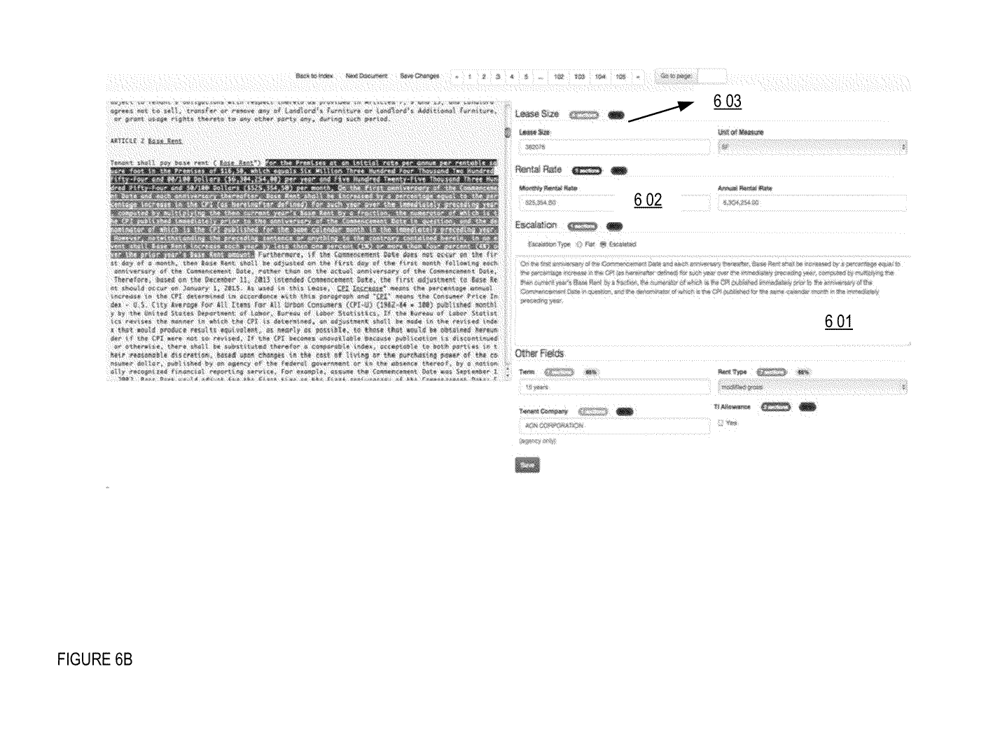

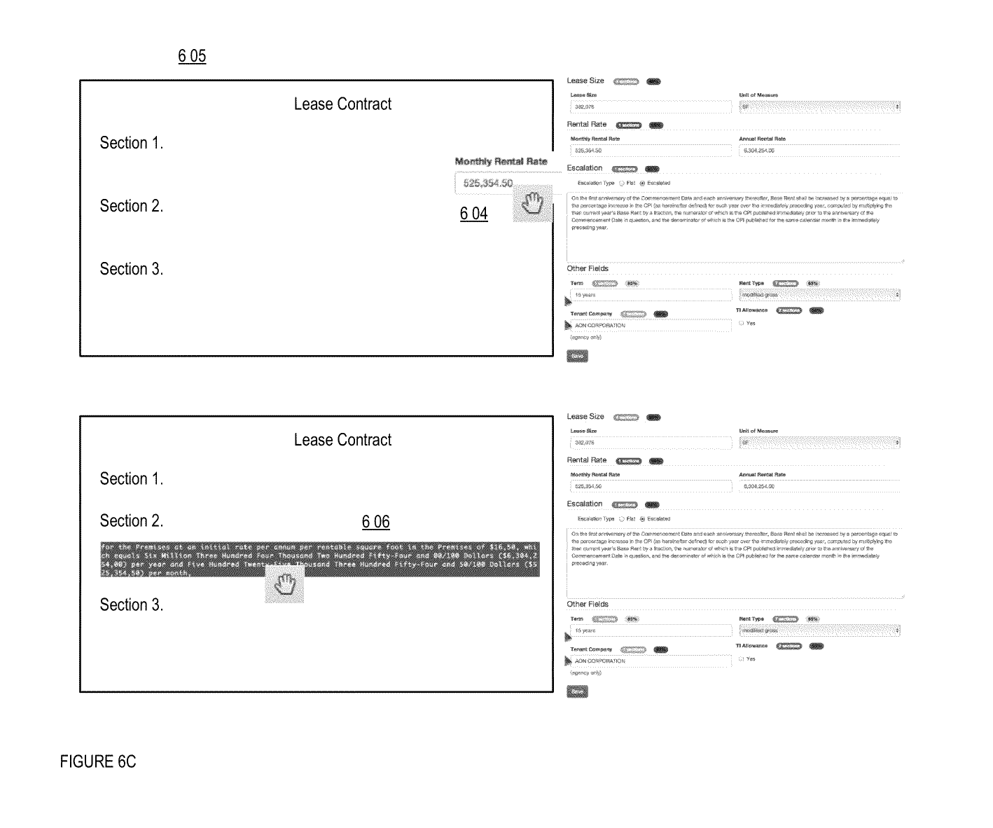

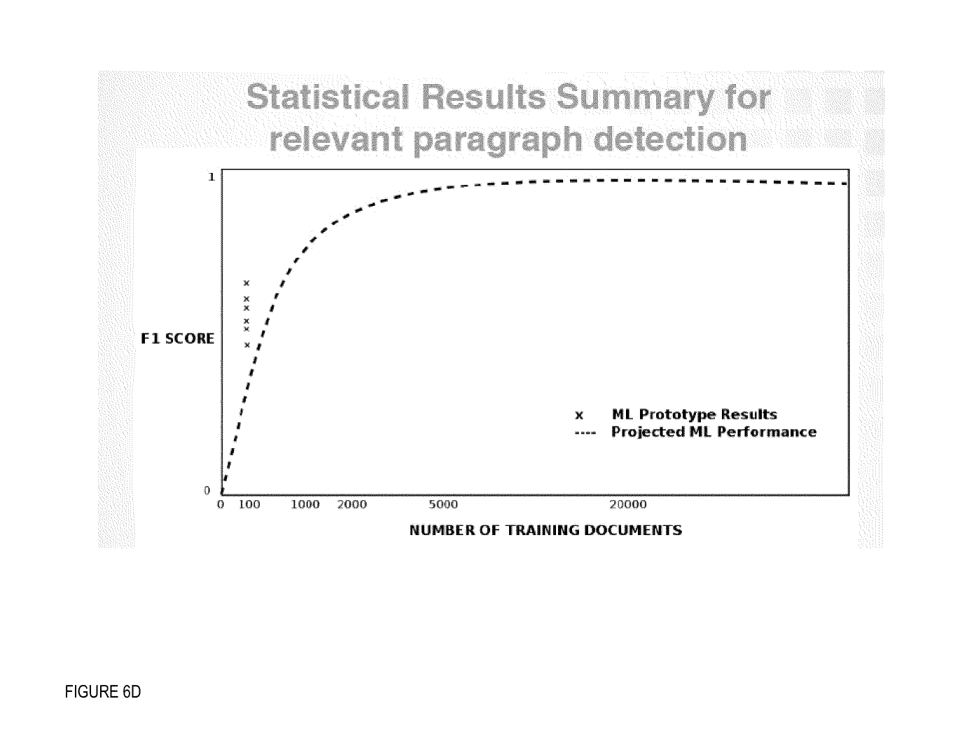

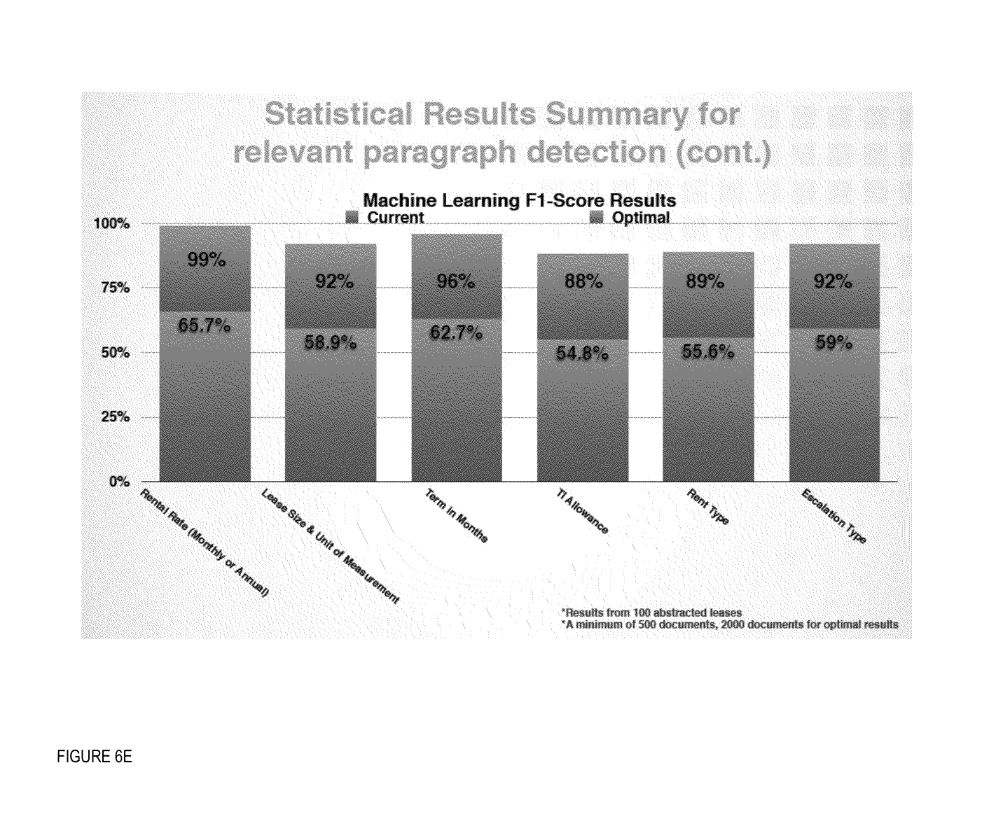

FIGS. 6A and 6B show screenshots of example user interface of the lease extraction embodiment of the MLDA. In one embodiment, the different colors indicate different lease abstraction field types. Data entry staff may quickly navigate through paragraphs relevant to a particular abstraction field and skip reading most of the lease document. In another embodiment, the abstraction fields are pre-populated in the web form (e.g., 601, 602). A confidence score 603 next to each field indicates the probability that the predicted value is correct. Fields below a threshold probability are color-coded in yellow and red.

In some embodiment, the MLDA may first classify paragraphs into relevant to a lease abstraction field or not. A Machine Learning approach that treats paragraphs as “bags of words” may be used. The MLDA may then apply “document classification” techniques to classify the paragraphs into one of the abstraction field categories using binary classification. In one implementation, the paragraph may be classified into relevant or not relevant to each field type. The MLDA may use the Support Vector Machines learning algorithm and/or other supervised learning algorithms. The MLDA may use the Gate NLP framework and the LibSVM library. An alternative library may be weka. Other document classification techniques that may be utilized in the MLDA may include, but not limited to, Expectation maximization (EM), Naive Bayes classifier, Tf-idf, Latent semantic indexing, Artificial neural network, K-nearest neighbour algorithms, Decision trees such as ID3 or C4.5, Concept Mining, Rough set based classifier, Soft set based classifier, Multiple-instance learning, Natural language processing approaches, and/or the like.

In one embodiment, the bag-of-words approach may consider only individual tokens (unigrams). Providing more contextual information (sequence of words), e.g. bi-grams (sequence of 2 words) may improve accuracy. Additionally, a basic token normalization may be implemented: converting numbers to a common format. Additional token normalization may also be used to improve results, e.g. converting proper names, addresses, etc. to a common format.

The rules may consist of all words across all paragraphs in the training set, which include, but not limited to:

totalNumDocs=1041530
..................... .
_ngram_ADDED<> 6921 2
_ngram_ADDENDUM<> 17435 27
_ngram_ADDITION<> 15199 18
_ngram_ADDITIONAL<> 5995 38
_ngram_ADDITIONALLY<> 38508 1
_ngram_ADDITIONALRENT<> 53435 1
_ngram_ADDITIONS<> 36 9
_ngram_ADDRESS<> 8129 28
_ngram_ADDRESSED<> 10074 4
_ngram_ADE<> 37412 1
............
_ngram_Beneficiaiy<> 16907 1
_ngram_Beneficial<> 17092 6
_ngram_Beneficiaries<> 19476 10
_ngram_Beneficiary<> 6221 71
_ngram_Benefit<> 22235 2
_ngram_Benefits<> 27201 1
_ngram_Benjamin<> 14856 2
_ngram_Benoit<> 18463 2
_ngram_Benoy<> 41381 1
_ngram_Berit<> 15132 1
............... . .

Based on the above features (or rules), word vectors may be computed for each of the lease paragraphs. These word vectors may look as follows (the format is word id, column, the normalized value of its number of occurrences in the paragraph), but not limited to:

0 97 doc0.pdf
1 0 14:0.3707481 121:0.378158 7122:0.50607985 36050:0.6807537
2 0 1:0.21218616 2:0.06678862 9:0.14623865 14:0.13480517 16:0.13519925
23:0.1251564 24:0.13567026 26:0.11841079 27:0.12315218 28:0.09894525
78:0.1545195 121:0.13749944 128:0.15460774 164:0.07878209 165:0.11244823
169:0.11532411 170:0.07293262 237:0.07988669 344:0.08852427 368:0.09138584
378:0.08550918 398:0.083293505 436:0.15248986 437:0.20308691 453:0.14903349
458:0.12749718 463:0.15369871 469:0.12387718 707:0.12167553 1172:0.13243604
2667:0.14846633 3404:0.1701609 5139:0.1481208 5857:0.14661214 6869:0.15465936
7122:0.18401223 8857:0.19492537 12340:0.24752419 15284:0.19914818
17687:0.2103775 36050:0.24752419 38344:0.21551658 42928:0.24752419
3 0 305:0.41491222 5856:0.90986145
4 0 1:0.12953119 164:0.14427997 165:0.2059355 169:0.21120232 170:0.20035107
237:0.14630292 305:0.1663167 368:0.16736224 370:0.17190245 409:0.21040702
463:0.28148082 469:0.22686625 1311:0.24171771 2903:0.23993818 5370:0.3399281
5507:0.34203947 5857:0.2685026 15284:0.36471605
5 0 1:0.26779243 2:0.06654592 23:0.033253755 25:0.056358546 28:0.21031614
47:0.049512632 64:0.052205067 78:0.23093696 81:0.07641238 82:0.04382082
128:0.23106885 164:0.03139832 165:0.05975445 169:0.107244685 170:0.23253627
200:0.054814976 201:0.17393138 229:0.115119666 237:0.031838555 278:0.12986058
283:0.04961362 298:0.13130541 339:0.032744672 343:0.031663034 345:0.13558777
351:0.05649092 378:0.17039688 398:0.033196326 411:0.042517945 412:0.04506306
417:0.0665346 423:0.06538145 436:0.20258093 437:0.20234889 445:0.06830152
456:0.040759154 467:0.0456627 473:0.055347234 506:0.08692084 551:0.05438569
730:0.04621313 740:0.053636074 913:0.058951646 922:0.04964274 938:0.060580894
1241:0.0491496 1740:0.051565576 2022:0.084938705 2191:0.09632661
3298:0.07011948 3419:0.10389982 3829:0.21042493 5139:0.11806603 5142:0.06727603
5612:0.06938232 5857:0.49666977 15135:0.13876463 15282:0.14985219
15285:0.1165302 27005:0.098649874
6 0 1:0.2969249 2:0.084115215 9:0.12278435 16:0.113515474 23:0.10508335
24:0.11391094 26:0.09941961 27:0.103400566 78:0.0973028 85:0.10013344
128:0.09735837 164:0.16536678 165:0.25176895 169:0.19365597 170:0.18370624
201:0.109926164 229:0.12126108 237:0.06707416 339:0.06898308 344:0.0743264
345:0.19042814 346:0.08260792 347:0.0744702 366:0.077231646 378:0.07179489
398:0.06993458 399:0.094093926 410:0.07119242 436:0.1707106 437:0.17051506
439:0.06581044 545:0.08980582 560:0.11388234 564:0.12968968 574:0.10665539
624:0.082448974 786:0.11141195 906:0.10112506 928:0.109675005 1017:0.1504006
1239:0.10345748 1905:0.12784134 2076:0.14067098 2191:0.20293091 2257:0.13349424
2261:0.11766399 2540:0.12769714 2628:0.1260667 4566:0.13773885 4617:0.16935435
5857:0.12309792 14779:0.32031712 15284:0.16720803
.................. . . .

In one embodiment, providing dictionaries with keywords relevant to each field type may be used to boost results. These dictionaries may be created automatically or semi-automatically using training data and input from trained legal professionals. Lastly, the MLDA may include more contextual information such as the relative position of the paragraph in the document, the section heading of the paragraph if available, etc.

In one embodiment, after the paragraph classification, additional techniques for extracting field values for each lease abstraction field may be performed. In the case of multi-value fields (dropdowns in the UI), document classification techniques may be applied that classify a previously identified paragraph. For example, a paragraph referring to Rent Type is then classified into one of the Rent Type categories. In the case of free-text fields, the MLDA may apply standard named entity recognition techniques to identify words and phrases that contain the field value. In one embodiment, the MLDA may classify individual tokens (from a previously identified paragraph) into referring to the value of an abstraction field or not.

FIG. 6C shows an example lease creator embodiment of the MLDA. In one embodiment, the MLDA may generate a shell of a contract, and allow to drag and drop terms into the shell contract. Lease languages may be generated automatically based on the terms. It allows the MLDA to place readily recoganizable texts and fields for the learning engine to read. For example, a user may drag and drop “Monthly Rental Rate” term 604 to the shell contract 605. Lease languages 606 associated with the term 604 may be automatically populated into the shell contract. This embodiment of the MLDA allows to create lease contract and/or PDF document field values and tags which are more readily, easily, and accurately identifiable by the learning engine.

FIGS. 6D-6E show example Machine Learning performance (F1-score) results in one embodiment of the MLDA. Based on various training dataset sizes, the figure illustrates that the performance may peak at 2,000 training documents and that 500 lease documents may be used to utilize MLDA for commercial use.

### MLDA Controller

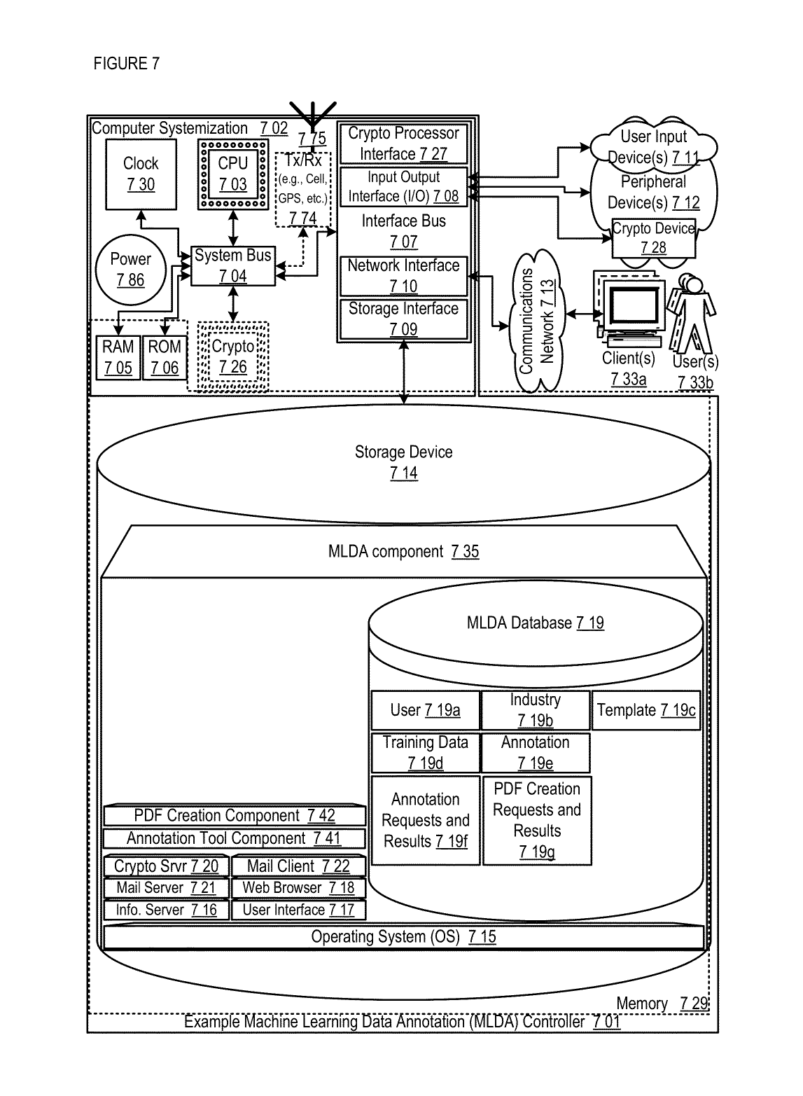

FIG. 7 shows a block diagram illustrating embodiments of an MLDA controller. In this embodiment, the MLDA controller 701 may serve to aggregate, process, store, search, serve, identify, instruct, generate, match, and/or facilitate interactions with a computer through behavior assessment technologies, and/or other related data.

Typically, users, which may be people and/or other systems, may engage information technology systems (e.g., computers) to facilitate information processing. In turn, computers employ processors to process information; such processors 703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MLDA controller 701 may be connected to and/or communicate with entities such as, but not limited to: one or more users from user input devices 711; peripheral devices 712; an optional cryptographic processor device 728; and/or a communications network 713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MLDA controller 701 may be based on computer systems that may comprise, but are not limited to, components such as: a computer systemization 702 connected to memory 729.

### Computer Systemization

A computer systemization 702 may comprise a clock 730, central processing unit (“CPU(s)” and/or “processor(s)” (these terms are used interchangeable throughout the disclosure unless noted to the contrary)) 703, a memory 729 (e.g., a read only memory (ROM) 706, a random access memory (RAM) 705, etc.), and/or an interface bus 707, and most frequently, although not necessarily, are all interconnected and/or communicating through a system bus 704 on one or more (mother)board(s) 702 having conductive and/or otherwise transportive circuit pathways through which instructions (e.g., binary encoded signals) may travel to effectuate communications, operations, storage, etc. The computer systemization may be connected to a power source 786; e.g., optionally the power source may be internal. Optionally, a cryptographic processor 726 and/or transceivers (e.g., ICs) 774 may be connected to the system bus. In another embodiment, the cryptographic processor and/or transceivers may be connected as either internal and/or external peripheral devices 712 via the interface bus I/O. In turn, the transceivers may be connected to antenna(s) 775, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing MLDA controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 729 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the MLDA controller and beyond through various interfaces. Should processing requirements dictate a greater amount speed and/or capacity, distributed processors (e.g., Distributed MLDA), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the MLDA may be achieved by implementing a microcontroller such as CAST's R8051XC2 microcontroller; Intel's MCS 51 (i.e., 8051 microcontroller); and/or the like. Also, to implement certain features of the MLDA, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MLDA component collection (distributed or otherwise) and/or features may be implemented via the microprocessor and/or via embedded components; e.g., via ASIC, coprocessor, DSP, FPGA, and/or the like. Alternately, some implementations of the MLDA may be implemented with embedded components that are configured and used to achieve a variety of features or signal processing.

Depending on the particular implementation, the embedded components may include software solutions, hardware solutions, and/or some combination of both hardware/software solutions. For example, MLDA features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MLDA features. A hierarchy of programmable interconnects allow logic blocks to be interconnected as needed by the MLDA system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the MLDA may be developed on regular FPGAs and then migrated into a fixed version that more resembles ASIC implementations. Alternate or coordinating implementations may migrate MLDA controller features to a final ASIC instead of or in addition to FPGAs. Depending on the implementation all of the aforementioned embedded components and microprocessors may be considered the “CPU” and/or “processor” for the MLDA.

### Power Source

The power source 786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the MLDA thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

### Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the MLDA controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MLDA), architectures may similarly be employed to pool, load balance, and/or otherwise increase the communicative bandwidth required by the MLDA controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 712 may be connected and/or communicate to I/O and/or other facilities of the like such as network interfaces, storage interfaces, directly to the interface bus, system bus, the CPU, and/or the like. Peripheral devices may be external, internal and/or part of the MLDA controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the MLDA controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the MLDA controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the MLDA controller and/or a computer systemization may employ various forms of memory 729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 729 may contain a collection of program and/or database components and/or data such as, but not limited to: operating system component(s) 715 (operating system); information server component(s) 716 (information server); user interface component(s) 717 (user interface); Web browser component(s) 718 (Web browser); database(s) 719; mail server component(s) 721; mail client component(s) 722; cryptographic server component(s) 720 (cryptographic server); the MLDA component(s) 735; and/or the like (i.e., collectively a component collection). These components may be stored and accessed from the storage devices and/or from storage devices accessible through an interface bus. Although non-conventional program components such as those in the component collection, typically, are stored in a local storage device 714, they may also be loaded and/or stored in memory such as: peripheral devices, RAM, remote storage facilities through a communications network, ROM, various forms of memory, and/or the like.

### Operating System

The operating system component 715 is an executable program component facilitating the operation of the MLDA controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MLDA controller to communicate with other entities through a communications network 713. Various communication protocols may be used by the MLDA controller as a subcarrier transport mechanism for interaction, such as, but not limited to: multicast, TCP/IP, UDP, unicast, and/or the like.

### Information Server

An information server component 716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MLDA controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MLDA database 719, operating systems, other program components, user interfaces, Web browsers, and/or the like.

Access to the MLDA database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MLDA. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MLDA as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 718 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the MLDA enabled nodes. The combined application may be nugatory on systems employing standard Web browsers.

### Mail Server

A mail server component 721 is a stored program component that is executed by a CPU 703. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MLDA.

Access to the MLDA mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 722 is a stored program component that is executed by a CPU 703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 720 is a stored program component that is executed by a CPU 703, cryptographic processor 726, cryptographic processor interface 727, cryptographic processor device 728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MLDA may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MLDA component to engage in secure transactions if so desired. The cryptographic component facilitates the secure accessing of resources on the MLDA and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MLDA Database

The MLDA database component 719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MLDA database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the MLDA database is implemented as a data-structure, the use of the MLDA database 719 may be integrated into another component such as the MLDA component 735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 719 includes several tables 719a-g. A User table 719a includes fields such as, but not limited to: user_id, user_name, user_employer, user_contact_address, industry_id, listing_id, and/or the like. An Industry table 719b includes fields such as, but not limited to: industry_id, industry_name, industry_first category, industry_second_category, and/or the like. A Template table 719c includes fields such as, but not limited to: template_id, industry_id, template_field_id, template_fields_value, and/or the like. A Training_Data table 719d includes fields such as, but not limited to: training_id, industry_id, data_field_id, data_field_value, annotation_flag, annotation_color, and/or the like. An Annotation table 719e includes fields such as, but not limited to: annotation_id, annotation_flag, annotation_color, industry_id, annotation_rules, ML_models, and/or the like. An annotation_requests and_results table 719f includes fields such as, but not limited to: request_id, user_id, industry_id, template_id, annotation_id, annotation_rules, annotation_flag, annotation_color, and/or the like. A PDF_creation_requests_and_results table 719g includes fields such as, but not limited to: request_id, user_id, industry_id, template_id, PDF_id, and/or the like.

In one embodiment, the MLDA database may interact with other database systems. For example, employing a distributed database system, queries and data access by search MLDA component may treat the combination of the MLDA database, an integrated data security layer database as a single database entity.

In one embodiment, user programs may contain various user interface primitives, which may serve to update the MLDA. Also, various accounts may require custom database tables depending upon the environments and the types of clients the MLDA may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 719a-g. The MLDA may be configured to keep track of various settings, inputs, and parameters via database controllers.

The MLDA database may communicate to and/or with other components in a component collection, including itself, and/or facilities of the like. Most frequently, the MLDA database communicates with the MLDA component, other program components, and/or the like. The database may contain, retain, and provide information regarding other nodes and data.

### The MLDAs

The MLDA component 735 is a stored program component that is executed by a CPU. In one embodiment, the MLDA component incorporates any and/or all combinations of the aspects of the MLDA that was discussed in the previous figures. As such, the MLDA affects accessing, obtaining and the provision of information, services, transactions, and/or the like across various communications networks.

The MLDA transforms data annotation request and Portable Document Format (PDF) creation request inputs via MLDA annotation tool 541 and PDF creation 542 components, into annotated data representation and data PDF representation outputs.

The MLDA component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MLDA server employs a cryptographic server to encrypt and decrypt communications. The MLDA component may communicate to and/or with other components in a component collection, including itself, and/or facilities of the like. Most frequently, the MLDA component communicates with the MLDA database, operating systems, other program components, and/or the like. The MLDA may contain, communicate, generate, obtain, and/or provide program component, system, user, and/or data communications, requests, and/or responses.

### Distributed MLDAs

The structure and/or operation of any of the MLDA node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the MLDA controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the MLDA controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for MACHINE LEARNING DATA ANNOTATION APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a MLDA individual and/or enterprise user, database configuration and/or relational model, data type, data transmission and/or network framework, syntax structure, and/or the like, various embodiments of the MLDA, may be implemented that enable a great deal of flexibility and customization. For example, aspects of the MLDA may be adapted for financial document annotation, product and service marketing. While various embodiments and discussions of the MLDA have included real estate applications, however, it is to be understood that the embodiments described herein may be readily configured and/or customized for a wide variety of other applications and/or implementations.

What is claimed is:

1. A processor-implemented confidence structured output document creation method, comprising:
receiving a unknown inconsistent structured document;
receiving an confidence information extraction feature;
parsing the unknown inconsistent structured document to retrieve data field tags and data field values;
processing the data field tags and the data field values with the confidence information extraction feature;
extracting processed data field tags and data field values;
providing processed data field tags and data field values to a confidence structured output document learning engine;
retrieving a confidence structured output document web form template;
populating the confidence structured output document web form template with the extracted data field tags and data field values to generate a confidence structured output document; and
providing the confidence structured output document.

2. The method of claim 1, further comprising:
receiving a confidence structured output document learning engine feedback from a crowd source, wherein the feedback includes an correction to at least one of the extracted processed data field tags or data field values; and
updating the confidence structured output document learning engine based on the feedback.

3. The method of claim 1, further comprising:
crawling the world wide web for structured documents in a similar subject matter of the unknown inconsistent structured document;
parsing the structured documents to generate a confidence structured output document learning engine feedback from a crowd source, wherein the feedback includes an correction to at least one of the extracted processed data field tags or data field values; and
updating the confidence structured output document learning engine based on the feedback.

4. The method of claim 1, wherein the unknown inconsistent structured document is a real estate property flyer.

5. The method of claim 1, wherein the data field tags include a property type, a listing type, a street address, a city address, a state address, a property value, a broker name, a broker company, and a broker contact method.

6. A consistently structured confidence document creation processor-implemented method, comprising:
receiving a consistently structured confidence document creation request;
parsing the consistently structured confidence document creation request to obtain a first data field and associate data value;
retrieving a consistently structured confidence document template;
wherein the consistently structured confidence document template comprises a second data field;
comparing the first data field and the second data field;
when the first data field matches the second data field, adding the associate data value in the second data field in the property representation template; and
providing the p consistently structured confidence document template with the added associated data values for representation.

7. The method of claim 6, wherein the consistently structured confidence document is a property Portable Document Format (PDF) document.

8. The method of claim 6, wherein the consistently structured confidence document is a property lease contract document.

9. A machine learning data annotation processor-implemented method to transform data annotation request input to annotated data representation output, comprising:
receiving an initial annotation data set;
receiving an initial annotation rule;
parsing the initial annotation data set to retrieve unprocessed data fields;
processing the retrieved unprocessed data fields with the initial annotation rule;
highlighting a discerned document part;
extracting processed data fields with the highlighted document part;
retrieving a web form template;
populating the web form template with the extracted data fields;
providing the populated web form template with the extracted data fields;
receiving a correction on the highlighted document part;
updating the initial annotation data set with the correction to generate a new annotation data set;
generating a machine learning model based on the received correction; and
storing the new annotation data set and the machine learning model.

10. The method of claim 9, wherein the populated web form template with the extracted data fields is provided to multiple crowd-sourced entities.

11. The method of claim 9, wherein the received correction on the highlighted document type is obtained from multiple crowd-sourced entities.

12. A processor-readable tangible medium storing processor-issuable confidence structured output document creation instructions to:receive a unknown inconsistent structured document;
receive an confidence information extraction feature;
parse the unknown inconsistent structured document to retrieve data field tags and data field values;
process the data field tags and the data field values with the confidence information extraction feature;
extract processed data field tags and data field values;
provide processed data field tags and data field values to a confidence structured output document learning engine;
retrieve a confidence structured output document web form template;
populate the confidence structured output document web form template with the extracted data field tags and data field values to generate a confidence structured output document; and
provide the confidence structured output document.

13. The medium of claim 12, further comprising:
receive a confidence structured output document learning engine feedback from a crowd source, wherein the feedback includes an correction to at least one of the extracted processed data field tags or data field values; and
update the confidence structured output document learning engine based on the feedback.

14. The medium of claim 12, further comprising:
crawl the world wide web for structured documents in a similar subject matter of the unknown inconsistent structured document;
parse the structured documents to generate a confidence structured output document learning engine feedback from a crowd source, wherein the feedback includes an correction to at least one of the extracted processed data field tags or data field values; and
update the confidence structured output document learning engine based on the feedback.

15. The medium of claim 12, wherein the unknown inconsistent structured document is a real estate property flyer.

16. The medium of claim 12, wherein the data field tags include a property type, a listing type, a street address, a city address, a state address, a property value, a broker name, a broker company, and a broker contact method.

17. A confidence structured output document creation processor-implemented system, comprising:
means to receive a unknown inconsistent structured document;
means to receive an confidence information extraction feature;
means to parse the unknown inconsistent structured document to retrieve data field tags and data field values;
means to process the data field tags and the data field values with the confidence information extraction feature;
means to extract processed data field tags and data field values;
means to provide processed data field tags and data field values to a confidence structured output document learning engine;
means to retrieve a confidence structured output document web form template;
means to populate the confidence structured output document web form template with the extracted data field tags and data field values to generate a confidence structured output document; and
means to provide the confidence structured output document.

18. The system of claim 17, further comprising:
means to receive a confidence structured output document learning engine feedback from a crowd source, wherein the feedback includes an correction to at least one of the extracted processed data field tags or data field values; and
means to update the confidence structured output document learning engine based on the feedback.

19. The system of claim 17, further comprising:
means to crawl the world wide web for structured documents in a similar subject matter of the unknown inconsistent structured document;
means to parse the structured documents to generate a confidence structured output document learning engine feedback from a crowd source, wherein the feedback includes an correction to at least one of the extracted processed data field tags or data field values; and
means to update the confidence structured output document learning engine based on the feedback.

20. A confidence structured output document creation processor-implemented apparatus, comprising:
a processor; and
a memory disposed in communication with the processor and storing processor-issuable instructions to:
receive a unknown inconsistent structured document;
receive an confidence information extraction feature;
parse the unknown inconsistent structured document to retrieve data field tags and data field values;
process the data field tags and the data field values with the confidence information extraction feature;
extract processed data field tags and data field values;
provide processed data field tags and data field values to a confidence structured output document learning engine;
retrieve a confidence structured output document web form template;
populate the confidence structured output document web form template with the extracted data field tags and data field values to generate a confidence structured output document; and
provide the confidence structured output document.
